(19) United States
(12) Patent Application Publication
(10) Pub. No.: US 2026/0136388 A1
(43) Pub. Date: May 14, 2026

(54) INDICATING LBT RESULTS IN RANDOM ACCESS REPORT

(71) Applicant: Telefonaktiebolaget LM Ericsson (PUBL), Stockholm (SE)

(72) Inventors: Ali Parichehrehteroujeni, LINKÖPING (SE); Luca Lunardi, GENOA (IT)

(21) Appl. No.: 19/120,116

(22) PCT Filed: Oct. 12, 2023
(86) PCT No.: PCT/IB2023/060312

§ 371 Date: Apr. 10, 2025

Related U.S. Application Data
(60) Provisional application No. 63/379,202, filed on Oct. 12, 2022.

(51) Int. Cl. H04W 74/0808; H04B 7/06; H04W 36/00; H04W 74/0833

(52) U.S. Cl. CPC H04W 74/0808; H04B 7/0626; H04W 36/0058; H04W 74/0833

(57) ABSTRACT

According to some embodiments, a method is performed by wireless device. The method comprises, upon performing a random-access procedure in a shared spectrum and experiencing a listen-before-talk (LBT) problem when attempting to transmit a preamble using a beam, logging random access information in a random access report. The random access information comprises a number of LBT problems experienced when attempting to transmit the preamble using the beam and an identifier of the beam. The method further comprises transmitting the random access report to a network node.

### TECHNICAL FIELD

Embodiments of the present disclosure are directed to wireless communications and, more particularly, to indicating listen-before-talk (LBT) results in a random access report.

### BACKGROUND

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

FIG. 1 illustrates the current next generation (NG) radio access network (RAN) architecture (Third Generation Partnership Project (3GPP) TS 38.401 v16.6.0 (2021-06)). The NG-RAN consists of a set of gNBs connected to the fifth generation core (5GC) through the NG interface. As specified in 3GPP TS 38.300, the NG-RAN may also consist of a set of ng-eNBs. An ng-eNB may consist of a control unit (ng-eNB-CU) and one or more distributed units (ng-eNB-DU(s)). An ng-eNB-CU and an ng-eNB-DU are connected via the W1 interface. The general principles described herein also apply to an ng-eNB and the W1 interface, if not explicitly specified otherwise.

A gNB can support frequency division duplex (FDD) mode, time division duplex (TDD) mode or dual mode operation. A gNBs can be interconnected to another gNB through the Xn interface.

A gNB may consist of a control unit (gNB-CU) and one or more distributed units (gNB-DU(s)). A gNB-CU and a gNB-DU are connected via the F1 interface. One gNB-DU is connected to only one gNB-CU. The NG, Xn and F1 are logical interfaces.

For NG-RAN, the NG and Xn-C interfaces for a gNB consisting of a gNB-CU and gNB-DUs terminate in the gNB-CU. For Evolved-Universal Terrestrial Radio Access-New Radio Dual Connectivity (EN-DC), the S1-U and X2-C interfaces for a gNB consisting of a gNB-CU and gNB-DUs terminate in the gNB-CU. The gNB-CU and connected gNB-DUs are only visible to other gNBs and the 5GC as a gNB.

FIG. 2 illustrates the overall architecture for separation of gNB-CU-CP (for the control plane) and gNB-CU-UP (for the user plane). The gNB-CU-CP is connected to the gNB-CU-UP via the E1 interface. The gNB-DU is connected to the gNB-CU-CP via the F1-C interface and the gNB-CU-UP via the F1-U interface.

NR targets both licensed and unlicensed bands. Allowing unlicensed networks, i.e., networks that operate in shared spectrum (or unlicensed spectrum) to effectively use the available spectrum is an attractive approach to increase system capacity. Although unlicensed spectrum does not match the qualities of the licensed regime, solutions that facilitate an efficient use of unlicensed spectrum as a complement to licensed deployments have the potential to bring great value to the 3GPP operators, and, ultimately, to the 3GPP industry as a whole. Some features in NR need to be adapted to comply with the special characteristics of the unlicensed band as well as different regulations. A subcarrier spacing of 15 or 30 kHz are the most promising candidates for NR-U orthogonal frequency division multiplexing (OFDM) numerologies for frequencies below 6 GHz.

When operating in unlicensed spectrum many regions in the world require a device to sense the medium as free before transmitting. This operation is often referred to as listen-before-talk (LBT).

Listen-before-talk is designed for unlicensed spectrum co-existence with other radio access technologies (RATs). When using LBT, a radio device applies a clear channel assessment (CCA) check (i.e., channel sensing) before transmission. The transmitter involves energy detection (ED) over a time period compared to a certain threshold (ED threshold) to determine if a channel is idle.

LBT parameter settings (including ED) may be set for devices in a network by a network node configuring the devices in the network. The limits may be set as pre-defined rules or tables in specifications or regulatory requirements for operation in a certain region. Such limits are part of the European Telecommunications Standards Institute (ETSI) harmonized standard in Europe as well as the 3GPP specification for operation of Long Term Evolution (LTE)/NR-U in unlicensed spectrum.

3GPP TS 37.213 v17.1.0 (2022-03), clause 4 specifies some general terminology applicable to channel access procedure for shared spectrum (e.g., for NR-U for NR and licensed assisted access (LAA) for LTE).

A channel refers to a carrier or a part of a carrier consisting of a contiguous set of resource blocks (RBs) on which a channel access procedure is performed in shared spectrum.

A channel access procedure is a procedure based on sensing that evaluates the availability of a channel for performing transmissions. The basic unit for sensing is a sensing slot with a duration Tₛₗ=9 us. The sensing slot duration Tₛₗ is considered to be idle if an eNB/gNB or a user equipment (UE) senses the channel during the sensing slot duration, and determines that the detected power for at least 4 us within the sensing slot duration is less than energy detection threshold X_{Thresh}. Otherwise, the sensing slot duration Tₛₗ is considered to be busy.

A channel occupancy refers to transmission(s) on channel(s) by eNB/gNB/UE(s) after performing the corresponding channel access procedures in this clause.

A channel occupancy time (COT) refers to the total time for which eNB/gNB/UE and any eNB/gNB/UE(s) sharing the channel occupancy perform transmission(s) on a channel after an eNB/gNB/UE performs the corresponding channel access procedures described in this clause. For determining a channel occupancy time, if a transmission gap is less than or equal to 25 us, the gap duration is counted in the channel occupancy time. A channel occupancy time can be shared for transmission between an eNB/gNB and the corresponding UE(s).

A downlink transmission burst is defined as a set of transmissions from an eNB/gNB without any gaps greater than 16 us. Transmissions from an eNB/gNB separated by a gap of more than 16 us are considered as separate downlink transmission bursts. An eNB/gNB can transmit transmission(s) after a gap within a downlink transmission burst without sensing the corresponding channel(s) for availability.

An uplink transmission burst is defined as a set of transmissions from a UE without any gaps greater than 16 us. Transmissions from a UE separated by a gap of more than 16 us are considered as separate uplink transmission bursts. A UE can transmit transmission(s) after a gap within an uplink transmission burst without sensing the corresponding channel(s) for availability.

A discovery burst refers to a downlink transmission burst including a set of signal(s) and/or channel(s) confined within a window and associated with a duty cycle. The discovery burst can be any of the following: (a) transmission(s) initiated by an eNB that includes a primary synchronization signal (PSS), secondary synchronization signal (SSS) and cell-specific reference signal(s) (CRS) and may include non-zero power channel state information (CSI) reference signals (CSI-RS); and (b) transmission(s) initiated by a gNB that includes at least an SS/PBCH block consisting of a primary synchronization signal (PSS), secondary synchronization signal (SSS), physical broadcast channel (PBCH) with associated demodulation reference signal (DM-RS) and may also include a core resource set (CORESET) for physical downlink control channel (PDCCH) scheduling physical downlink shared channel (PDSCH) with system information block 1 (SIB1), and PDSCH carrying SIB1 and/or non-zero power CSI reference signals (CSI-RS).

Downlink channel access procedures are specified for an eNB operation LAA Scell(s) on channel(s) and a gNB performing transmission(s) on channel(s) according to 3GPP TS 37.213 clause 4.1. Clause 4.1.1 (“Type 1 DL channel access procedure”) describes the channel access procedure to be performed by an eNB/gNB, where the time duration spanned by the sensing slots that are sensed to be idle before a downlink (DL) transmission(s) is random.

The eNB/gNB may transmit a transmission after first sensing the channel to be idle during the sensing slot durations of a defer duration T_{d} and after the counter N is zero. The counter N is adjusted by sensing the channel for additional sensing slot duration(s) according to the steps below:
1) set N=Nᵢₙᵢₜ, where Nᵢₙᵢₜ is a random number uniformly distributed between 0 and CWₚ, and go to step 4;
2) if N>0 and the eNB/gNB chooses to decrement the counter, set N=N−1;
3) sense the channel for an additional sensing slot duration, and if the additional sensing slot duration is idle, go to step 4; else, go to step 5;
4) if N=0, stop; else, go to step 2.
5) sense the channel until either a busy sensing slot is detected within an additional defer duration T_{d} or all the sensing slots of the additional defer duration T_{d} are detected to be idle;
6) if the channel is sensed to be idle during all the sensing slot durations of the additional defer duration T_{d}, go to step 4; else, go to step 5;

In the steps above:
T_{d} is the defer duration and it consists of a duration T_{f}=16 us immediately followed by mₚ consecutive sensing slot durations Tₛₗ, and T_{f} includes an idle sensing slot duration Tₛₗ at start of T_{f}.
CWₚ is the Contention Window with value CW_{min,p}≤CWₚ≤CW_{max,p}
mₚ, CW_{min,p}, and CW_{max,p} are based on a Channel Access Priority Class (CAPC) p associated with the eNB/gNB transmission, as shown in Table 4.1.1-1.

TABLE 4.1.1-1
Channel Access Priority Class (CAPC)

| Channel | | | | | | |
|---|---|---|---|---|---|---|
| Access | | | | | | |
| Priority | | | | | | |
| Class (p) | mₚ | CW_{min, p} | CW_{max, p} | T_{m cot, p} | | allowed CWₚsizes |
| 1 | 1 | 3 | 7 | 2 | ms | {3, 7} |
| 2 | 1 | 7 | 15 | 3 | ms | {7, 15} |
| 3 | 3 | 15 | 63 | 8 or 10 | ms | {15, 31, 63} |
| 4 | 7 | 15 | 1023 | 8 or 10 | ms | {15, 31, 63, 127, |
| | | | | | | 255, 511, 1023} |

3GPP TS 38.321 v17.1.0 describes the “Random Access Preamble transmission” in clause 5.1.3 (an excerpt reproduced below), including aspects related to LBT failure indication. The “LBT failure detection and recovery procedure” in clause 5.21.2 of the same Technical Specification.

▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪▪
5.1.3 Random Access Preamble transmission
The MAC entity shall, for each Random Access Preamble:

| 1> | if PREAMBLE_TRANSMISSION_COUNTER is greater than one; and | |
|---|---|---|
| 1> | if the notification of suspending power ramping counter has not been received from | |
| | lower layers; and | |
| 1> | if LBT failure indication was not received from lower layers for the last Random | |
| | Access Preamble transmission; and | |
| 1> | if SSB or CSI-RS selected is not changed from the selection in the last Random Access | |
| | Preamble transmission: | |
| | 2> | increment PREAMBLE_POWER_RAMPING_COUNTER by 1. |
| 1> | select the value of DELTA_PREAMBLE according to clause 7.3; | |
| 1> | set PREAMBLE_RECEIVED_TARGET_POWER to preambleReceivedTargetPower + | |
| | DELTA_PREAMBLE + (PREAMBLE_POWER_RAMPING_COUNTER − 1) × | |
| | PREAMBLE_POWER_RAMPING_STEP + POWER_OFFSET_2STEP_RA; | |
| 1> | except for contention-free Random Access Preamble for beam failure recovery request, | |
| | compute the RA-RNTI associated with the PRACH occasion in which the Random | |
| | Access Preamble is transmitted; | |
| 1> | instruct the physical layer to transmit the Random Access Preamble using the selected | |
| | PRACH occasion, corresponding RA-RNTI (if available), PREAMBLE_INDEX, and | |
| | PREAMBLE_RECEIVED_TARGET_POWER. | |
| 1> | if LBT failure indication is received from lower layers for this Random Access | |
| | Preamble transmission: | |
| | 2> | if lbt-FailureRecoveryConfig is configured: |

| | |
|---|---|
| 3> | perform the Random Access Resource selection procedure (see clause 5.1.2). |

| | |
|---|---|
| 2> | else: |

| | |
|---|---|
| 3> | increment PREAMBLE_TRANSMISSION_COUNTER by 1; |
| 3> | if PREAMBLE_TRANSMISSION_COUNTER = preambleTransMax + 1: |

| | |
|---|---|
| 4> | if the Random Access Preamble is transmitted on the SpCell: |

| | |
|---|---|
| 5> | indicate a Random Access problem to upper layers; |
| 5> | if this Random Access procedure was triggered for SI request: |

| | |
|---|---|
| 6> | consider the Random Access procedure unsuccessfully completed. |

| | |
|---|---|
| 4> | else if the Random Access Preamble is transmitted on an SCell: |

| | |
|---|---|
| 5> | consider the Random Access procedure unsuccessfully completed. |

| | |
|---|---|
| 3> | if the Random Access procedure is not completed: |

| | |
|---|---|
| 4> | perform the Random Access Resource selection procedure (see clause 5.1.2). |

***************************************************************************

A proposal is to enhance the radio link failure (RLF) report with the number of consistent LBT failures (and related LBT configuration) so that the network node receiving the RLF report can assess whether the failure in question should be accounted for mobility robustness optimization (MRO).

The number of consistent LBT failures and bandwidth part (BWP) specific lbt-FailureRecovery Config can further reveal the transmission scenario in uplink for NR-U. These parameters help the network to evaluate the channel load and influence from LBT failures during data transmission. The above-mentioned parameters should be further included in the RLF report for better RLF optimization.

In one proposal for NR-U RLF optimization, additional enhancements may include the average sensing time, ratio of idle contention window, early data transmission (EDT) in uplink, and the number of consistent LBT failures and related LBT configurations.

Random access reports may be enhanced by including, among other things, an indication of LBT failure per RA attempt. For example, the following may be added to the RA report: indication of LBT failures per RA attempt and/or the measured received signal strength indicator (RSSI) per RA attempt. Regarding the EDT in uplink used by the UE, it may be sufficient to have an indication of it per RA procedure. Other parameters may include: indication of LBT failure per RA attempt; measured RSSI per RA attempt; and EDT in uplink per RA procedure.

There currently exist certain challenges. For example, the proposals above suffer from at least the following limitations. Only including the “number of consistent LBT failures” provides a coarse indication that failures have occurred, and it is enough to pinpoint that a problem exists due to LBT, and to some extent also how frequent the problem occur, but it does not provide enough information on how to solve the problem. Including an indication of LBT failure per RA attempt produces a significantly large amount of information. Thus, while it is good in terms of granularity, a UE may not be able to collect all the information and/or there may be redundant information which makes the content of the UE report unnecessarily large and cumbersome (e.g., in terms of processing power) for the UE to produce.

### SUMMARY

As described above, certain challenges currently exist with indicating listen-before-talk (LBT) results in a random access report. Certain aspects of the present disclosure and their embodiments may provide solutions to these or other challenges. For example, in particular embodiments a wireless terminal (e.g., user equipment (UE)) may perform the following steps. Upon performing a random-access procedure in a shared spectrum and experiencing listen-before-talk (LBT) issue when attempting to transmit the preamble on the selected reference signals (e.g., beam), the wireless terminal logs random-access related information and measurements in a random-access report (e.g., RA-Report).

The wireless terminal may log information concerning the number of LBT failures experienced when attempting to transmit preambles on/using the selected reference signal/beam in the RA-Report. The reference signal may be synchronization signal block (SSB) beam or channel state information reference signal (CSI-RS) beam. In an embodiment, the above information is logged as part of RA-InformationCommon. In another embodiment, the information is logged as part of RA-InformationCommon and included in the radio link failure report, successful handover report (SHR), or successful PSCell change/addition report (SPR).

The wireless terminal may receive a request from a network node to send to the network node the logged information indicated above and send the report upon receiving such request.

In general, particular embodiments facilitate a UE to report to a network node per indication concerning LBT issues occurring during random access procedures with a per reference signal (e.g., the number of LBT issue experienced per selected SSB beam or selected CSI-RS beam) granularity (e.g., per SSB beam or per CSI-RS beam).

According to some embodiments, a method is performed by wireless device. The method comprises, upon performing a random-access procedure in a shared spectrum and experiencing a LBT problem when attempting to transmit a preamble using a beam, logging random access information in a random access report. The random access information comprises a number of LBT problems experienced when attempting to transmit the preamble using the beam and an identifier of the beam. The method further comprises transmitting the random access report to a network node.

In particular embodiments, the identifier of the beam comprises one of a synchronization signal block (SSB) identifier or a channel state information reference signal (CSI-RS) identifier.

In particular embodiments, the random access information is logged as part of RA-InformationCommon. The RA-InformationCommon may be included in a radio link failure report, successful handover report (SHR), or successful PSCell change/addition report (SPR).

In particular embodiments, the random access information is included: only as part of per random access SSB information; only as part of a radio link failure (RLF) report; only as part of a random access (RA) report; only as part of RA-InformationCommon; or as part of/together with a successful handover report. The random access information may be included: only as part of per random access CSI-RS information; as part of per random access SSB information and part of per random access CSI-RS information; as part of RLF report and part of a RA report, but not part of RA-InformationCommon; together with a RLF report; together with a RA report; as part of/together with a connection establishment failure report; or as part of/together with a successful primary Secondary Cell Group (SCG) cell (PSCell) change/addition report.

In particular embodiments, the method further comprises receiving a request from the network node for the random access report. The request may comprise one or more of: a part of a RLF report configuration; a part of a RA report configuration; a part of both RLF report and RA report configuration; a part of a successful handover report (SHR) configuration; and a part of a successful PSCell change/addition report (SPR) configuration.

In particular embodiments, the wireless device logs LBT failures according to one or more of the following conditions: for SSB beams; for CSI-RS beams; for a mobility procedure; for a preparation phase of a mobility procedure; for an execution phase of a mobility procedure; only for a source shared channel/source cell of a mobility procedure; only for a target shared channel/target cell of a mobility procedure; for both a source shared channel/source cell and a target shared channel/target cell of a mobility procedure; for initial access; for PSCell change; for PSCell addition; for a reconfiguration with synchronization associated to a specific purpose; upon transitioning from RRC_IDLE to RRC_CONNECTED state; upon transitioning from RRC_INACTIVE to RRC_CONNECTED state; upon transitioning between single connectivity and multi-connectivity operation; and in conjunction with a trigger of a radio related event.

According to some embodiments, a wireless device comprises processing circuitry operable to perform any of the wireless device methods described above.

A computer program product comprises a non-transitory computer readable medium storing computer readable program code, the computer readable program code operable, when executed by processing circuitry to perform any of the methods performed by the wireless device described above.

According to some embodiments, a method performed by a network node comprises configuring a wireless device for logging random access information associated with LBT problems and receiving random access information associated with LBT problems from the wireless device. The random access information comprises a number of LBT problems experienced when attempting to transmit a preamble using a beam and an identifier of the beam.

In particular embodiments, the method further comprises performing a mobility robustness operation based on the received random access information.

In particular embodiments, the method further comprises transmitting a request to the wireless device for the random access report. The request may comprise one or more of: a part of a RLF report configuration; a part of a RA report configuration; a part of both RLF report and RA report configuration; a part of a SHR configuration; and a part of a successful SPR configuration.

According to some embodiments, a network node comprises processing circuitry operable to perform any of the network node methods described above.

Another computer program product comprises a non-transitory computer readable medium storing computer readable program code, the computer readable program code operable, when executed by processing circuitry to perform any of the methods performed by the network node described above.

Certain embodiments may provide one or more of the following technical advantages. For example, particular embodiments provide network nodes with sufficient information to analyze the impact of LBT issues when performing random access procedures for various purpose such as mobility procedures or beam failure recovery or for specific feature(s) (e.g., Msg3 repetition or small data transmission (SDT) operation) activation, etc.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 illustrates the current next generation (NG) radio access network (RAN) architecture;

FIG. 2 illustrates the overall architecture for separation of gNB-CU-CP and gNB-CU-UP;

FIG. 3 is a block diagram illustrating an example wireless network;

FIG. 4 illustrates an example user equipment, according to certain embodiments;

FIG. 5 illustrates an example virtualization environment, according to certain embodiments;

FIG. 6 illustrates an example telecommunication network connected via an intermediate network to a host computer, according to certain embodiments;

FIG. 7 illustrates an example host computer communicating via a base station with a user equipment over a partially wireless connection, according to certain embodiments;

FIG. 8 is a flowchart illustrating a method implemented in a communication system, according to certain embodiments;

FIG. 9 is a flowchart illustrating a method implemented in a communication system, according to certain embodiments;

FIG. 10 is a flowchart illustrating a method implemented in a communication system, according to certain embodiments;

FIG. 11 is a flowchart illustrating a method implemented in a communication system, according to certain embodiments;

FIG. 12 is a flowchart illustrating an example method performed by a wireless device, according to particular embodiments; and

FIG. 13 is a flowchart illustrating an example method performed by a network node, according to particular embodiments.

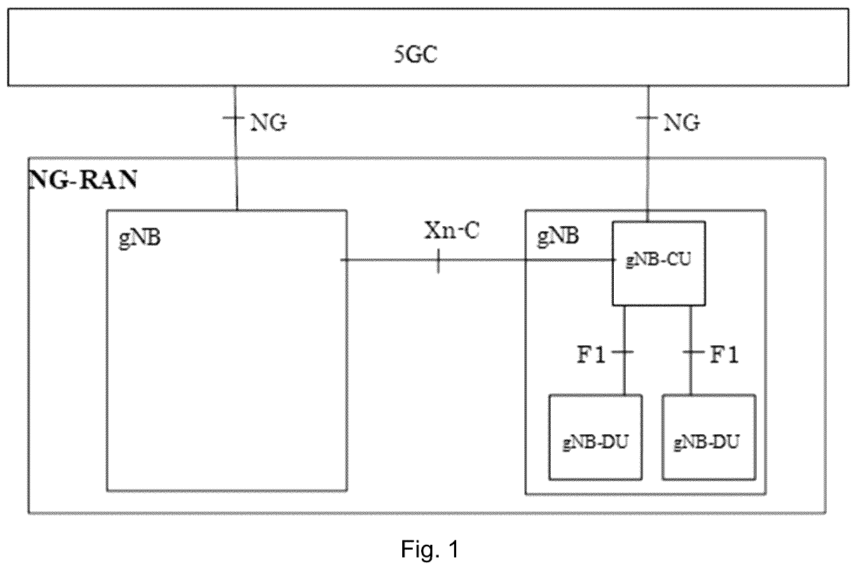

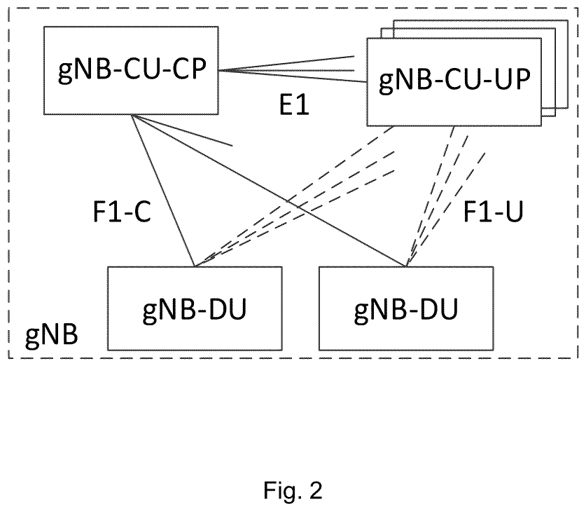

### DETAILED DESCRIPTION

Some of the embodiments will now be described more fully with reference to the accompanying drawings. Embodiments are provided by way of example to convey the scope of the subject matter to those skilled in the art.

As used herein, a network node can be a radio access network (RAN) node, an operations administration and management (OAM) node, a core network node, a service management and orchestration (SMO) node, a network management system (NMS), a non-real time RAN intelligent controller (Non-RT RIC), a real-time RAN intelligent controller (RT-RIC), a gNB, eNB, en-gNB, ng-eNB, gNB-CU, gNB-CU-CP, gNB-CU-UP, eNB-CU, eNB-CU-CP, eNB-CU-UP, integrated access and backhaul (IAB)-node, IAB-donor DU, IAB-donor-CU, IAB-DU, IAB-MT, open radio access network (O-RAN) network node (e.g., O-CU, O-CU-CP, O-CU-UP, O-DU, O-RU, or O-eNB), a cloud-based network function, or a cloud-based centralized training node.

The terms New Radio (NR) unlicensed and NR-U are used interchangeably and represent a type of shared spectrum for NR.

The description provided for NR unlicensed should not be regarded as limiting in terms of applicability of embodiments to different Third Generation Partnership Project (3GPP) generations, i.e., embodiments are applicable to 3GPP generations preceding NR (such as Long Term Evolution (LTE)) and to 3GPP generation following NR, such as sixth generation (6G), as long as the UE and the network node operates in shared spectrum.

“LBT issue” or “LBT failure” terms are used to indicate a situation where a UE performs channel sensing and determines that the channel is occupied by other transmitters such as other UEs, other RAN nodes or other non-3GPP transmitters, e.g., Wi-Fi nodes. Determining that the channel is occupied may use various approaches. In a non-limiting example, the UE measures the received signal strength indicator (RSSI) value of the channel and compares it with a configured threshold and if the measured RSSI is above the configured threshold, the UE determines the channel is occupied, which is referred to as LBT issue, LBT failure, and/or LBT problem.

According to some embodiments, a method performed by a wireless terminal (e.g., UE) comprises the following steps. Upon performing a random-access procedure in a shared spectrum and experiencing LBT issue/problem (e.g., sensing performed to evaluate the availability of a channel for performing transmissions, i.e., the channel access procedure indicates that the channel is busy) when attempting to transmit the preamble on the selected reference signals (e.g., beam) (LBT issue can be an instance of LBT failure or detection of consistent LBT failure), the UE logs random-access related information and measurements in a random-access report (e.g., RA-Report).

The UE may log information concerning the number of LBT issue experienced when attempting to transmit the preamble on/using the selected reference signal/beam in the RA-Report. In an embodiment, the above information is logged as part of RA-InformationCommon. In another embodiment, the information is logged as part of RA-InformationCommon and included in the radio link failure report or in a successful handover report.

The UE operating in shared spectrum logs the requested information and includes it, for example, according to one of the following options:
only as part of per Random Access SSB Information (e.g., as part of PerRASSBInfo-r16 IE)
only as part of per Random Access CSI-RS Information (e.g. as part of PerCSI-RSInfor-r16 IE)
as part of per Random Access SSB Information and part of per Random Access CSI-RS Information
only as part of a radio link failure (RLF) report
only as part of a random access (RA) report
only as part of RA-InformationCommon
as part of RLF report and part of a RA report, but not part of RA-InformationCommon
together with a RLF report
together with a RA report
as part of/together with a Successful Handover Report (SHR)
as part of/together with a Connection Establishment Failure Report
as part of/together with a Successful PSCell change/addition report (SPR)
as part of/together with a new UE report

The UE may receive a request from a network node to send to the network node the logged information indicated above.

In one embodiment, the information associated to LBT failures as part of the request sent to the UE may be:
part of a RLF report configuration
part of a RA report configuration
part of both RLF report and RA report configuration (e.g., to be reported as part of RA-InformationCommon)
part of a SHR report configuration
part of a SPR (or SPCR) report configuration

In one embodiment, the UE may be configured for logging information associated to LBT failures when operating in NR-U according to one or more of the following conditions:
for SSB beams
for CSI-RS beams
for a mobility procedure
for the preparation phase of a mobility procedure
for the execution phase of a mobility procedure
only for the source shared channel/source cell of a mobility procedure
only for the target shared channel/target cell of a mobility procedure
for both the source shared channel/source cell and the target shared channel/target cell of a mobility procedure
for initial access
for PSCell change
for PSCell addition
for a reconfiguration with synch associated to a specific purpose
upon transitioning from RRC_IDLE to RRC_CONNECTED state
upon transitioning from RRC_INACTIVE to RRC_CONNECTED state
upon transitioning from single connectivity to multi-connectivity operation or vice versa
in conjunction with the trigger of a certain radio related event (e.g., when event A3, or event A5 is triggered)

In one embodiment, the UE may be configured for logging complementary information, in addition to the information associated to LBT failures, such as:
identity(ies) and attributes of BWP(s)
identity(ies) and attributes of shared channels
Uplink/Downlink Transmission Bandwidth
absolute radio-frequency channel number (ARFCN)
the operating band (e.g., for NR-U, band n96 or band n102)
the radio access technology (e.g. NR or LTE)
number of consistent LBT failures
channel access priority class
channel access procedure type (e.g., type 1, type 2 or type 3)
configured energy detection threshold in uplink
used energy detection threshold in uplink
channel occupancy time percentage in uplink
sensing duration before LBT failure or before consistent LBT failure
the Radio Resource Control (RRC) state of the UE
LBT configuration
Indications of UE timers running when LBT failure(s) or consistent LBT failure(s) is(are) detected (e.g. T304, T310, T312). In an embodiment the timers are associated to the MCG or to the SCG. In another embodiment the UE logs the timers status associated to both MCG and SCG.
percentage or certain UE timer(s) running when LBT failure(s) or consistent LBT failure(s) is(are) detected. In an embodiment the timers are associated to the MCG or to the SCG. In another embodiment the UE logs the timers status associated to both MCG and SCG.
indication(s) indicating which message(s) or which information the UE attempted to transmit, for which the transmission was not possible (or it was delayed) due to LBT failure, or due to consistent LBT failure. For instance, the UE failed to transmit Msg3.
the number of attempts made by the UE to transmit a certain message or information, which failed due to LBT failure or consistent LBT failure
the time spent by the UE in attempting to transmit a certain message or information, which due to LBT failure or consistent LBT failure
indication(s) indicating which message(s) or which information the UE expected to receive, for which the reception was not possible. For instance, the UE failed to receive a Random Access Response, or a MsgB.
Identifiers of a cell (e.g., NR Cell Global Identity (CGI), or NR Physical Cell Identity (PCI))
Identities of tracking area (e.g., 5GS Tracking Area Code (TAC), EPS TAC)
Public land mobile network (PLMN) identities
Indication of non-public network (NPN) support and/or NPN identities
Indication(s) and/or identities of network slice(s)
Identities of data radio bearer (DRB), or signaling radio bearer (SRB)

In another embodiment, the UE can log information associated to LBT failures without being configured/requested by the network e.g., as part of RLF report or a RA report, or an MCGFailureInformation or an SCGFailureInformation.

According to some embodiments, a method is performed by a network node. In one embodiment, a first network node configures a UE for logging information associated to LBT failures. The network node receives the requested information from the UE or from a second network node. The network node may (optionally) determines how to use the obtained radio measurements for mobility robustness optimization.

In one embodiment, a second network node requests a UE to provide information associated to LBT failures, (e.g. via UEInformationRequest message) and receives from the UE information associated to LBT failures. The second network node may determine to send the received information associated to LBT failures to another network node (e.g., the first network node). The second network node may send the received information associated to LBT failures reported by the UE to the first network node (e.g., via UEInformationResponse message).

In one embodiment, a first network node determines to transmit at least part of the information associated to LBT failures as received from a UE to a second network node.

In a first variant, the first network node is a first gNB (or a first RAN node), and the second network node is a second gNB (or a second RAN node).

In a second variant, the first network node is a first function of a first gNB (for example, the gNB-CU-CP of the first gNB), and the second network node is a second function of a first gNB (for example a gNB-DU served by the gNB-CU-CP of the first gNB).

The following are implementation examples that may be mapped to 3GPP TS 38.331. The following examples are non-limiting example implementations including a non-backward compatible change that may be fixed by putting the new information elements (IEs) at the right place, e.g., as a list under PerRAInfoList. This example is only used to show the new IEs concerning particular embodiments, but may be implemented in the different places in the Abstract Syntax Notation One (ASN.1) structure, e.g., as a list under PerRAInfoList-r16.

***************************************************************************

| | |
|---|---|
| 5.7.10.5 | RA information determination for RA report and RLF report |

The UE shall set the content in ra-InformationCommon as follows:

| 1> | set the absoluteFrequencyPointA to indicate the absolute frequency of the reference | |
|---|---|---|
| | resource block associated to the random-access resources used in the random-access | |
| | procedure; | |
| 1> | set the locationAndBandwidth and subcarrierSpacing associated to the UL BWP of the | |
| | random-access resources used in the random-access procedure; | |
| 1> | if contention based random-access resources are used in the random-access procedure: | |
| | 2> | set the msgA_RO-FrequencyStart and msgA-RO-FDM and msgA-Subcarrier Spacing |
| | | associated to the 2 step random- access resources if used in the random-access |
| | | procedure; |
| | 2> | if msgA-SubcarrierSpacing associated to the 2 step random-access resources used in |
| | | the random-access procedure is available: |

| | |
|---|---|
| 3> | set the msgA-SubcarrierSpacing associated to the 2 step random-access resources |
| | used in the random-access procedure; |

| | |
|---|---|
| 2> | else if only 2 step random-access resources are available in the UL BWP used in the |
| | random-access procedure: |

| | |
|---|---|
| 3> | set the msgA-SCS-From-prach-ConfigurationIndex to the subcarrier spacing as |
| | derived from the msgA-PRACH-ConfigurationIndex used in the 2-step random- |
| | access procedure; |

| | |
|---|---|
| 2> | else: |

| | |
|---|---|
| 3> | set the msg1-SubcarrierSpacing associated to the 4 step random-access resources |
| | used in the random-access procedure; |

| | |
|---|---|
| 2> | set the msg1-FrequencyStart associated to the 4 step random-access resources if |
| | used in the random-access procedure, and if its value is different from the value of |
| | msgA-RO-FrequencyStart if it is included in the ra-InformationCommon; |
| 2> | set the msg1-FDM associated to the 4 step random-access resources if used in the |
| | random-access procedure, and if its value is different from the value of msgA-RO- |
| | FDMCFRA if it is included in the ra-InformationCommon; |
| 2> | if msg1-SubcarrierSpacing associated to the 4 step random-access resources used in |
| | the random-access procedure is available, and if its value is different from the value |
| | of msgA-SubcarrierSpacing if it is included in the ra-InformationCommon: |

| | |
|---|---|
| 3> | set the msg1-SubcarrierSpacing associated to the 4 step random-access resources |
| | used in the random-access procedure; |

| | |
|---|---|
| 2> | else: |

| | |
|---|---|
| 3> | set the msg1-SCS-From-prach-ConfigurationIndex to the subcarrier spacing as |
| | derived from the prach-ConfigurationIndex used in the 4-step random-access |
| | procedure, and if its value is different from the value of msgA-SCS-From-prach- |
| | ConfigurationIndex if it is included in the ra-InformationCommon; |

| 1> | if contention free random-access resources are used in the random-access procedure: | |
|---|---|---|
| | 2> | set the msg1-FrequencyStartCFRA and msg1-FDMCFRA associated to the 4 step |
| | | random-access resources if used in the random-access procedure; |
| | 2> | if msg1-SubcarrierSpacing associated to the 4 step random-access resources used in |
| | | the random-access procedure is available: |

| | |
|---|---|
| 3> | set the msg1-SubcarrierSpacingCFRA associated to the 4 step random-access |
| | resources used in the random-access procedure; |

| | |
|---|---|
| 2> | else: |

| | |
|---|---|
| 3> | set the msg1-SCS-From-prach-ConfigurationIndexCFRA to the subcarrier |
| | spacing as derived from the prach-ConfigurationIndex used in the 4 step random- |
| | access procedure; |

| | |
|---|---|
| 2> | set the msgA-RO-FrequencyStartCFRA and msgA-RO-FDMCFRA associated to the |
| | 2 step contention free random access resources if used in the random-access |
| | procedure; |
| 2> | set the msgA-MCS, the nrofPRBs-PerMsgA-PO, the msgA-PUSCH- |
| | TimeDomainAllocation, the frequencyStartMsgA-PUSCH, the nrofMsgA-PO-FDM |
| | associated to the 2 step random-access resources if used in the random-access |
| | procedure; |
| 2> | if msgA-SubcarrierSpacing associated to the 2 step random-access resources used in |
| | the random-access procedure is available: |

| | |
|---|---|
| 3> | set the msgA-SubcarrierSpacing associated to the 2 step random-access resources |
| | used in the random-access procedure; |

| | |
|---|---|
| 2> | else if only 2 step random-access resources are available in the UL BWP used in the |
| | random-access procedure: |

| | |
|---|---|
| 3> | set the msgA-SCS-From-prach-ConfigurationIndex to the subcarrier spacing as |
| | derived from the msgA-PRACH-ConfigurationIndex used in the 2-step random- |
| | access procedure; |

| | |
|---|---|
| 2> | else: |

| | |
|---|---|
| 3> | set the msg1-SubcarrierSpacing associated to the 4 step random-access resources |
| | used in the random-access procedure; |

| 1> | if the random access procedure is initialized with RA_TYPE set to 2-stepRA as | |
|---|---|---|
| | described in TS 38.321: | |
| | 2> | set the dlPathlossRSRP to the measeured RSRP of the DL pathloss reference |
| | | obtained at the time of RA_Type selection stage of the initialization of the RA |
| | | procedure as captured in TS 38.321; |
| | 2> | if the configuration for the random access msgA-TransMax was configured in |
| | | RACH-ConfigDedicated for this random access procedure, and ra-Purpose is set to |
| | | reconfigurationWithSync: |

| | |
|---|---|
| 3> | set msgA-TransMax to the value of msgA-TransMax in RACH-ConfigDedicated; |

| | |
|---|---|
| 2> | else if msgA-TransMax was configured in RACH-ConfigCommonTwoStepRA: |

| | |
|---|---|
| 3> | set msgA-TransMax to the value of msgA-TransMax in RACH- |
| | ConfigCommonTwoStepRA; |

| | 2> | set the msgA-PUSCH-PayloadSize to the size of the overall payload available in the |
|---|---|---|
| | | UE buffer at the time of initiating the 2 step RA procedure; |
| 1> | if the purpose of the random access procedure is to request on-demand system | |
| | information (i.e., if the raPurpose is set to requestForOtherSI or | |
| | msg3RequestForOtherSI): | |
| | 2> | set the intendedSIBs to indicate the SIB(s) the UE wanted to receive as a result of the |
| | | SI request; |
| | 2> | set the ssbsForSI-Acquisition to indicate the SSB(s) used to receive the SI message; |
| | 2> | if the on-demand system information acquisition was successful: |

| | |
|---|---|
| 3> | set the onDemandSISuccess to true; |

| | |
|---|---|
| 2> | else: |

| | |
|---|---|
| 3> | set the onDemandSISuccess to false; |

| 1> | set the parameters associated to individual random-access attempt in the chronological | |
|---|---|---|
| | order of attempts in the perRAInfoList as follows: | |
| | 2> | if the random-access resource used is associated to a SS/PBCH block, set the |
| | | associated random-access parameters for the successive random-access attempts |
| | | associated to the same SS/PBCH block for one or more random-access attempts as |
| | | follows: |

| | |
|---|---|
| 3> | set the ssb-Index to include the SS/PBCH block index associated to the used |
| | random-access resource; |
| 3> | set the numberOfPreamblesSentOnSSB to indicate the number of successive |
| | random-access attempts associated to the SS/PBCH block; |
| 3> | set the numberOfLBTIssuesOnSSB to indicate the number of uplink LBT failures |
| | detected/measured/experienced during the random-access attempts associated to |
| | the SS/PBCH block; |
| 3> | for each random-access attempt performed on the random-access resource, |
| | include the following parameters in the chronological order of the random-access |
| | attempt: |

| | |
|---|---|
| 4> | if the random-access attempt is performed on the contention based random- |
| | access resource and if raPurpose is not equal to ‘requestForOtherSI’, include |
| | contentionDetected as follows: |

| | |
|---|---|
| 5> | if contention resolution was not successful as specified in TS 38.321 [6] for |
| | the transmitted preamble: |

| | |
|---|---|
| 6> | set the contentionDetected to true; |

| | |
|---|---|
| 5> | else: |

| | |
|---|---|
| 6> | set the contentionDetected to false; |

| | |
|---|---|
| 4> | if the random access attempt is a 2-step random access attempt: |

| | |
|---|---|
| 5> | if fallback from 2-step random access to 4-step random access occurred |
| | during the random access attempt: |

| | |
|---|---|
| 6> | set fallbackToFourStepRA to true; |

| | |
|---|---|
| 4> | if the random-access attempt is performed on the contention based random- |
| | access resource; or |
| 4> | if the random-access attempt is performed on the contention free random- |
| | access resource and if the random-access procedure was initiated due to the |
| | PDCCH ordering: |

| | |
|---|---|
| 5> | if the random access attempt is a 4-step random access attempt and the |
| | SS/PBCH block RSRP of the SS/PBCH block corresponding to the |
| | random-access resource used in the random-access attempt is above rsrp- |
| | ThresholdSSB; or |
| 5> | if the random access attempt is a 2-step random access attempt and the |
| | SS/PBCH block RSRP of the SS/PBCH block corresponding to the |
| | random-access resource used in the random-access attempt is above msgA- |
| | RSRP-ThresholdSSB: |

| | |
|---|---|
| 6> | set the dlRSRP AboveThreshold to true; |

| | |
|---|---|
| 5> | else: |

| | |
|---|---|
| 6> | set the dlRSRP AboveThreshold to false; |

| | |
|---|---|
| 2> | else if the random-access resource used is associated to a CSI-RS, set the associated |
| | random-access parameters for the successive random-access attempts associated to |
| | the same CSI-RS for one or more random-access attempts as follows: |

| | |
|---|---|
| 3> | set the csi-RS-Index to include the CSI-RS index associated to the used random- |
| | access resource; |
| 3> | set the numberOfPreamblesSentOnCSI-RS to indicate the number of successive |
| | random-access attempts associated to the CSI-RS. |
| 3> | set the numberOfLBTIssuesOnCSI-RS to indicate the number of uplink LBT |
| | failures detected/measured/experienced during the random-access attempts |
| | associated to the CSI-RS; |

RA-ReportList-r16 ::= SEQUENCE (1..maxRAReport-r16)) OF RA-Report-r16

| | |
|---|---|
| RA-Report-r16 ::= | SEQUENCE { |

| | |
|---|---|
| cellId-r16 | CHOICE { |
| cellGlobalId-r16 | CGI-Info-Logging-r16, |
| pci-arfcn-r16 | PCI-ARFCN-NR-r16 |

},

| | |
|---|---|
| ra-InformationCommon-r16 | OPTIONAL, |

| | |
|---|---|
| raPurpose-r16 | ENUMERATED {accessRelated, beamFailureRecovery, |

reconfigurationWithSync, ulUnSynchronized,

schedulingRequestFailure,

noPUCCHResourceAvailable, requestForOthersSI,

msg3RequestForOtherSI-r17, spare8, spare7,

spare6, spare5, spare4, spare3,

spare2, spare1},

```
  ...,
  [[
```

| | |
|---|---|
| spCellID-r17 | CGI-Info-Logging-r16 |

OPTIONAL
]]
}

| | |
|---|---|
| RA-InformationCommon-r16 ::= | SEQUENCE { |

| | |
|---|---|
| absoluteFrequencyPointA-r16 | ARFCN-ValueNR, |
| locationAndBandwidth-r16 | INEGER (0..37949), |
| subcarrierSpacing-r16 | SubcarrierSpacing, |
| msg1-FrequencyStart-r16 | INTEGER (0..maxNrofPhysicalResourceBlocks-1) |

OPTIONAL,

| | |
|---|---|
| msg1-FrequencyStartCFRA-r16 | INTEGER (0..maxNrofPhysicalResourceBlocks-1) |

OPTIONAL,

| | |
|---|---|
| msg1-SubcarrierSpacing-r16 | SubcarrierSpacing |

OPTIONAL,

| | |
|---|---|
| msg1--SubcarrierSpacingCFRA-r16 | SubcarrierSpacing |

OPTIONAL,

| | |
|---|---|
| msg1-FDM-r16 | ENUMERATED {one, two, four, eight} |

OPTIONAL,

| | |
|---|---|
| msg1-FDMCFRA-r16 | ENUMERATED {one, two, four, eight} |

OPTIONAL,

| | |
|---|---|
| perRAInfoList-r16 | PerRAInfoList-r16, |

```
  ...,
  [[
```

| | | |
|---|---|---|
| perRAInfoList-v1660 | PerRAInfoList-v1660 | OPTIONAL |

```
  ]],
  [[
```

| | |
|---|---|
| msg1-SCS-From-prach-ConfigrationIndex-r16 | ENUMERATED {kHz1dot25, kHz5, spare2, spare1} |

```
OPTIONAL
  ]],
  [[
```

| | |
|---|---|
| msg1-SCS-From-prach-ConfigrationIndexCFRA-r16 | ENUMERATED {kHz1dot25, kHz5, spare2, |

```
spare1} OPTIONAL
  ]],
  [[
```

| | |
|---|---|
| msgA-RO-FrequencyStart-r17 | INTEGER (0..maxNrofPhysicalResourceBlocks-1) |

OPTIONAL,

| | |
|---|---|
| msgA-RO-FrequencyStartCFRA-r17 | INTEGER (0..maxNrofPhysicalResourceBlocks-1) |

OPTIONAL,

| | |
|---|---|
| msgA-SubcarrierSpacing-r17 | SubcarrierSpacing |

OPTIONAL,

| | |
|---|---|
| msgA-RO-FDM-r17 | ENUMERATED {one, two, four, eight} |

OPTIONAL,

| | |
|---|---|
| msgA-RO-FDMCFRA-r17 | ENUMERATED {one, two, four, eight} |

OPTIONAL,

| | |
|---|---|
| msgA-SCS-From-prach-ConfigurationIndex-r17 | ENUMERATED {kHz1dot25, kHz5, spare2, spare1} |

OPTIONAL,

| | |
|---|---|
| msgA-TransMax-r17 | ENUMERATED {n1, n2, n4, n6, n8, n10, n20, n50, n100, |

n200} OPTIONAL,

| | |
|---|---|
| msgA-MCS-r17 | INTEGER (0..15) |

OPTIONAL,

| | |
|---|---|
| nrofPRBs-PerMsgA-PO-r17 | INTEGER (1..32) |

OPTIONAL,

| | |
|---|---|
| msgA-PUSCH-TimeDomainAllocation-r17 | INTEGER (1..maxNrofUL-Allocations) |

OPTIONAL,

| | |
|---|---|
| frequencyStartMsgA-PUSCH-r17 | INTEGER (0..maxNrofPhysicalResourceBlocks-1) |

OPTIONAL,

| | |
|---|---|
| nrofMsgA-PO-FDM-r17 | ENUMERATED {one, two, four, eight} |

OPTIONAL,

| | |
|---|---|
| dlPathlossRSRP-r17 | RSRP-Range |

OPTIONAL,

| | |
|---|---|
| intendedSIBs-r17 | SEQUENCE (SIZE (1..maxSIB)) OF SIB-Type-r17 |

OPTIONAL,

| | |
|---|---|
| ssbsForSI-Acquisition-r17 | SEQUENCE (SIZE (1..maxNrofSSBs-r16)) OF SSB-Index |

OPTIONAL,

| | |
|---|---|
| msgA-PUSCH-PayloadSize-r17 | BIT STRING (SIZE (5)) |

OPTIONAL,

| | |
|---|---|
| onDemandSISuccess-r17 | ENUMERATED {true} |

OPTIONAL
]]
}
PerRAInfoList-r16 ::= SEQUENCE (SIZE (1..200)) OF PerRAInfo-r16
PerRAInfoList-v1660 ::= SEQUENCE (SIZE (1..200)) OF PerRACSI-RSInfo-v1660

| | |
|---|---|
| PerRAInfo-r16 ::= | CHOICE { |

| | |
|---|---|
| perRASSBInfoList-r16 | PerRASSBInfo-r16, |
| perRACSI-RSInfoList-r16 | PerRACSI-RSInfo-r16 |

}

| | |
|---|---|
| PerRASSBInfo-r16 ::= | SEQUENCE { |

| | |
|---|---|
| ssb-Index-r16 | SSB-Index, |
| numberOfPreamblesSentOnSSB-r16 | INTEGER (1..200), |
| perRAAttemptInfoList-r16 | PerRAAttemptInfoList-r16, |
| numberOfLBTIssuesOnSSB-r18 | INTEGER (1.. 128) |

}

| | |
|---|---|
| PerRACSI-RSInfo-r16 ::= | SEQUENCE { |

| | |
|---|---|
| csi-RS-Index-r16 | CSI-RS-Index, |
| numberOfPreamblesSentOnCSI-RS-r16 | INTEGER (1..200), |
| numberOfLBTIssuesOnCSI-RS-r18 | INTEGER (1.. 128) |

}

| | |
|---|---|
| PerRACSI-RSInfo-v1660 ::= | SEQUENCE { |

| | | |
|---|---|---|
| csi-RS-Index-v1660 | INTEGER (1..96) | OPTIONAL |

}

| | |
|---|---|
| PerRAAttemptInfoList-r16 ::= | SEQUENCE (SIZE (1..200)) OF PerRAAttemptInfo-r16 |
| PerRAAttemptInfo-r16 ::= | SEQUENCE { |

| | | |
|---|---|---|
| contentionDetected-r16 | BOOLEAN | OPTIONAL, |
| dlRSRPAboveThreshold-r16 | BOOLEAN | OPTIONAL, |

```
  ...,
  [[
```

| | | |
|---|---|---|
| fallbackToFourStepRA-r17 | ENUMERATED {true} | OPTIONAL |

]]
}
SIB-Type-r17 ::= ENUMERATED {sibType2, sibType3, sibType4, sibType5, sibType9, sibType10-
v1610, sibType11-v1610, sibType12-v1610,

sibType13-v1610, sibType14-v1610, spare6, spare5, spare4, spare3,

spare2, spare1}
***************************************************************************

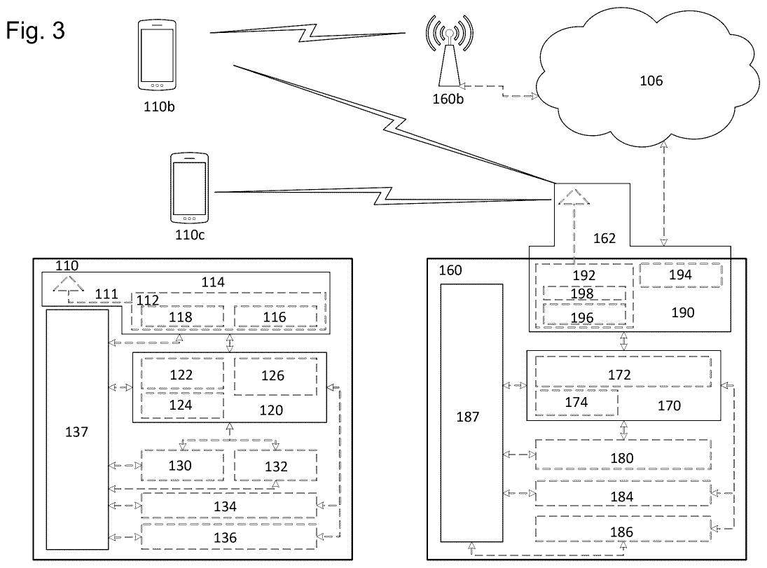

FIG. 3 illustrates an example wireless network, according to certain embodiments. The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 160 and WD 110 comprise various components described in more detail below. These components work together to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network.

Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations.

A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs.

As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 3, network node 160 includes processing circuitry 170, device readable medium 180, interface 190, auxiliary equipment 184, power source 186, power circuitry 187, and antenna 162. Although network node 160 illustrated in the example wireless network of FIG. 3 may represent a device that includes the illustrated combination of hardware components, other embodiments may comprise network nodes with different combinations of components.

It is to be understood that a network node comprises any suitable combination of hardware and/or software needed to perform the tasks, features, functions and methods disclosed herein. Moreover, while the components of network node 160 are depicted as single boxes located within a larger box, or nested within multiple boxes, in practice, a network node may comprise multiple different physical components that make up a single illustrated component (e.g., device readable medium 180 may comprise multiple separate hard drives as well as multiple RAM modules).

Similarly, network node 160 may be composed of multiple physically separate components (e.g., a NodeB component and a RNC component, or a BTS component and a BSC component, etc.), which may each have their own respective components. In certain scenarios in which network node 160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node.

In some embodiments, network node 160 may be configured to support multiple radio access technologies (RATs). In such embodiments, some components may be duplicated (e.g., separate device readable medium 180 for the different RATs) and some components may be reused (e.g., the same antenna 162 may be shared by the RATs). Network node 160 may also include multiple sets of the various illustrated components for different wireless technologies integrated into network node 160, such as, for example, GSM, WCDMA, LTE, NR, WiFi, or Bluetooth wireless technologies. These wireless technologies may be integrated into the same or different chip or set of chips and other components within network node 160.

Processing circuitry 170 is configured to perform any determining, calculating, or similar operations (e.g., certain obtaining operations) described herein as being provided by a network node. These operations performed by processing circuitry 170 may include processing information obtained by processing circuitry 170 by, for example, converting the obtained information into other information, comparing the obtained information or converted information to information stored in the network node, and/or performing one or more operations based on the obtained information or converted information, and as a result of said processing making a determination.

Processing circuitry 170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 160 components, such as device readable medium 180, network node 160 functionality.

For example, processing circuitry 170 may execute instructions stored in device readable medium 180 or in memory within processing circuitry 170. Such functionality may include providing any of the various wireless features, functions, or benefits discussed herein. In some embodiments, processing circuitry 170 may include a system on a chip (SOC).

In some embodiments, processing circuitry 170 may include one or more of radio frequency (RF) transceiver circuitry 172 and baseband processing circuitry 174. In some embodiments, radio frequency (RF) transceiver circuitry 172 and baseband processing circuitry 174 may be on separate chips (or sets of chips), boards, or units, such as radio units and digital units. In alternative embodiments, part or all of RF transceiver circuitry 172 and baseband processing circuitry 174 may be on the same chip or set of chips, boards, or units.

In certain embodiments, some or all of the functionality described herein as being provided by a network node, base station, eNB or other such network device may be performed by processing circuitry 170 executing instructions stored on device readable medium 180 or memory within processing circuitry 170. In alternative embodiments, some or all of the functionality may be provided by processing circuitry 170 without executing instructions stored on a separate or discrete device readable medium, such as in a hard-wired manner. In any of those embodiments, whether executing instructions stored on a device readable storage medium or not, processing circuitry 170 can be configured to perform the described functionality. The benefits provided by such functionality are not limited to processing circuitry 170 alone or to other components of network node 160 but are enjoyed by network node 160 as a whole, and/or by end users and the wireless network generally.

Device readable medium 180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 170. Device readable medium 180 may store any suitable instructions, data or information, including a computer program, software, an application including one or more of logic, rules, code, tables, etc. and/or other instructions capable of being executed by processing circuitry 170 and, utilized by network node 160. Device readable medium 180 may be used to store any calculations made by processing circuitry 170 and/or any data received via interface 190. In some embodiments, processing circuitry 170 and device readable medium 180 may be considered to be integrated.

Interface 190 is used in the wired or wireless communication of signaling and/or data between network node 160, network 106, and/or WDs 110. As illustrated, interface 190 comprises port(s)/terminal(s) 194 to send and receive data, for example to and from network 106 over a wired connection. Interface 190 also includes radio front end circuitry 192 that may be coupled to, or in certain embodiments a part of, antenna 162.

Radio front end circuitry 192 comprises filters 198 and amplifiers 196. Radio front end circuitry 192 may be connected to antenna 162 and processing circuitry 170. Radio front end circuitry may be configured to condition signals communicated between antenna 162 and processing circuitry 170. Radio front end circuitry 192 may receive digital data that is to be sent out to other network nodes or WDs via a wireless connection. Radio front end circuitry 192 may convert the digital data into a radio signal having the appropriate channel and bandwidth parameters using a combination of filters 198 and/or amplifiers 196. The radio signal may then be transmitted via antenna 162. Similarly, when receiving data, antenna 162 may collect radio signals which are then converted into digital data by radio front end circuitry 192. The digital data may be passed to processing circuitry 170. In other embodiments, the interface may comprise different components and/or different combinations of components.

In certain alternative embodiments, network node 160 may not include separate radio front end circuitry 192, instead, processing circuitry 170 may comprise radio front end circuitry and may be connected to antenna 162 without separate radio front end circuitry 192. Similarly, in some embodiments, all or some of RF transceiver circuitry 172 may be considered a part of interface 190. In still other embodiments, interface 190 may include one or more ports or terminals 194, radio front end circuitry 192, and RF transceiver circuitry 172, as part of a radio unit (not shown), and interface 190 may communicate with baseband processing circuitry 174, which is part of a digital unit (not shown).

Antenna 162 may include one or more antennas, or antenna arrays, configured to send and/or receive wireless signals. Antenna 162 may be coupled to radio front end circuitry 192 and may be any type of antenna capable of transmitting and receiving data and/or signals wirelessly. In some embodiments, antenna 162 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 162 may be separate from network node 160 and may be connectable to network node 160 through an interface or port.

Antenna 162, interface 190, and/or processing circuitry 170 may be configured to perform any receiving operations and/or certain obtaining operations described herein as being performed by a network node. Any information, data and/or signals may be received from a wireless device, another network node and/or any other network equipment. Similarly, antenna 162, interface 190, and/or processing circuitry 170 may be configured to perform any transmitting operations described herein as being performed by a network node. Any information, data and/or signals may be transmitted to a wireless device, another network node and/or any other network equipment.

Power circuitry 187 may comprise, or be coupled to, power management circuitry and is configured to supply the components of network node 160 with power for performing the functionality described herein. Power circuitry 187 may receive power from power source 186. Power source 186 and/or power circuitry 187 may be configured to provide power to the various components of network node 160 in a form suitable for the respective components (e.g., at a voltage and current level needed for each respective component). Power source 186 may either be included in, or external to, power circuitry 187 and/or network node 160.

For example, network node 160 may be connectable to an external power source (e.g., an electricity outlet) via an input circuitry or interface such as an electrical cable, whereby the external power source supplies power to power circuitry 187. As a further example, power source 186 may comprise a source of power in the form of a battery or battery pack which is connected to, or integrated in, power circuitry 187. The battery may provide backup power should the external power source fail. Other types of power sources, such as photovoltaic devices, may also be used.

Alternative embodiments of network node 160 may include additional components beyond those shown in FIG. 3 that may be responsible for providing certain aspects of the network node's functionality, including any of the functionality described herein and/or any functionality necessary to support the subject matter described herein. For example, network node 160 may include user interface equipment to allow input of information into network node 160 and to allow output of information from network node 160. This may allow a user to perform diagnostic, maintenance, repair, and other administrative functions for network node 160.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air.

In some embodiments, a WD may be configured to transmit and/or receive information without direct human interaction. For instance, a WD may be designed to transmit information to a network on a predetermined schedule, when triggered by an internal or external event, or in response to requests from the network.

Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device.

As yet another specific example, in an Internet of Things (IoT) scenario, a WD may represent a machine or other device that performs monitoring and/or measurements and transmits the results of such monitoring and/or measurements to another WD and/or a network node. The WD may in this case be a machine-to-machine (M2M) device, which may in a 3GPP context be referred to as an MTC device. As one example, the WD may be a UE implementing the 3GPP narrow band internet of things (NB-IoT) standard. Examples of such machines or devices are sensors, metering devices such as power meters, industrial machinery, or home or personal appliances (e.g. refrigerators, televisions, etc.) personal wearables (e.g., watches, fitness trackers, etc.).

In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 110 includes antenna 111, interface 114, processing circuitry 120, device readable medium 130, user interface equipment 132, auxiliary equipment 134, power source 136 and power circuitry 137. WD 110 may include multiple sets of one or more of the illustrated components for different wireless technologies supported by WD 110, such as, for example, GSM, WCDMA, LTE, NR, WiFi, WiMAX, or Bluetooth wireless technologies, just to mention a few. These wireless technologies may be integrated into the same or different chips or set of chips as other components within WD 110.

Antenna 111 may include one or more antennas or antenna arrays, configured to send and/or receive wireless signals, and is connected to interface 114. In certain alternative embodiments, antenna 111 may be separate from WD 110 and be connectable to WD 110 through an interface or port. Antenna 111, interface 114, and/or processing circuitry 120 may be configured to perform any receiving or transmitting operations described herein as being performed by a WD. Any information, data and/or signals may be received from a network node and/or another WD. In some embodiments, radio front end circuitry and/or antenna 111 may be considered an interface.

As illustrated, interface 114 comprises radio front end circuitry 112 and antenna 111. Radio front end circuitry 112 comprise one or more filters 118 and amplifiers 116. Radio front end circuitry 112 is connected to antenna 111 and processing circuitry 120 and is configured to condition signals communicated between antenna 111 and processing circuitry 120. Radio front end circuitry 112 may be coupled to or a part of antenna 111. In some embodiments, WD 110 may not include separate radio front end circuitry 112; rather, processing circuitry 120 may comprise radio front end circuitry and may be connected to antenna 111. Similarly, in some embodiments, some or all of RF transceiver circuitry 122 may be considered a part of interface 114.

Radio front end circuitry 112 may receive digital data that is to be sent out to other network nodes or WDs via a wireless connection. Radio front end circuitry 112 may convert the digital data into a radio signal having the appropriate channel and bandwidth parameters using a combination of filters 118 and/or amplifiers 116. The radio signal may then be transmitted via antenna 111. Similarly, when receiving data, antenna 111 may collect radio signals which are then converted into digital data by radio front end circuitry 112. The digital data may be passed to processing circuitry 120. In other embodiments, the interface may comprise different components and/or different combinations of components.

Processing circuitry 120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 110 components, such as device readable medium 130, WD 110 functionality. Such functionality may include providing any of the various wireless features or benefits discussed herein. For example, processing circuitry 120 may execute instructions stored in device readable medium 130 or in memory within processing circuitry 120 to provide the functionality disclosed herein.

As illustrated, processing circuitry 120 includes one or more of RF transceiver circuitry 122, baseband processing circuitry 124, and application processing circuitry 126. In other embodiments, the processing circuitry may comprise different components and/or different combinations of components. In certain embodiments processing circuitry 120 of WD 110 may comprise a SOC. In some embodiments, RF transceiver circuitry 122, baseband processing circuitry 124, and application processing circuitry 126 may be on separate chips or sets of chips.

In alternative embodiments, part or all of baseband processing circuitry 124 and application processing circuitry 126 may be combined into one chip or set of chips, and RF transceiver circuitry 122 may be on a separate chip or set of chips. In still alternative embodiments, part or all of RF transceiver circuitry 122 and baseband processing circuitry 124 may be on the same chip or set of chips, and application processing circuitry 126 may be on a separate chip or set of chips. In yet other alternative embodiments, part or all of RF transceiver circuitry 122, baseband processing circuitry 124, and application processing circuitry 126 may be combined in the same chip or set of chips. In some embodiments, RF transceiver circuitry 122 may be a part of interface 114. RF transceiver circuitry 122 may condition RF signals for processing circuitry 120.

In certain embodiments, some or all of the functionality described herein as being performed by a WD may be provided by processing circuitry 120 executing instructions stored on device readable medium 130, which in certain embodiments may be a computer-readable storage medium. In alternative embodiments, some or all of the functionality may be provided by processing circuitry 120 without executing instructions stored on a separate or discrete device readable storage medium, such as in a hard-wired manner.

In any of those embodiments, whether executing instructions stored on a device readable storage medium or not, processing circuitry 120 can be configured to perform the described functionality. The benefits provided by such functionality are not limited to processing circuitry 120 alone or to other components of WD 110, but are enjoyed by WD 110, and/or by end users and the wireless network generally.

Processing circuitry 120 may be configured to perform any determining, calculating, or similar operations (e.g., certain obtaining operations) described herein as being performed by a WD. These operations, as performed by processing circuitry 120, may include processing information obtained by processing circuitry 120 by, for example, converting the obtained information into other information, comparing the obtained information or converted information to information stored by WD 110, and/or performing one or more operations based on the obtained information or converted information, and as a result of said processing making a determination.

Device readable medium 130 may be operable to store a computer program, software, an application including one or more of logic, rules, code, tables, etc. and/or other instructions capable of being executed by processing circuitry 120. Device readable medium 130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 120. In some embodiments, processing circuitry 120 and device readable medium 130 may be integrated.

User interface equipment 132 may provide components that allow for a human user to interact with WD 110. Such interaction may be of many forms, such as visual, audial, tactile, etc. User interface equipment 132 may be operable to produce output to the user and to allow the user to provide input to WD 110. The type of interaction may vary depending on the type of user interface equipment 132 installed in WD 110. For example, if WD 110 is a smart phone, the interaction may be via a touch screen; if WD 110 is a smart meter, the interaction may be through a screen that provides usage (e.g., the number of gallons used) or a speaker that provides an audible alert (e.g., if smoke is detected).

User interface equipment 132 may include input interfaces, devices and circuits, and output interfaces, devices and circuits. User interface equipment 132 is configured to allow input of information into WD 110 and is connected to processing circuitry 120 to allow processing circuitry 120 to process the input information. User interface equipment 132 may include, for example, a microphone, a proximity or other sensor, keys/buttons, a touch display, one or more cameras, a USB port, or other input circuitry. User interface equipment 132 is also configured to allow output of information from WD 110, and to allow processing circuitry 120 to output information from WD 110. User interface equipment 132 may include, for example, a speaker, a display, vibrating circuitry, a USB port, a headphone interface, or other output circuitry. Using one or more input and output interfaces, devices, and circuits, of user interface equipment 132, WD 110 may communicate with end users and/or the wireless network and allow them to benefit from the functionality described herein.

Auxiliary equipment 134 is operable to provide more specific functionality which may not be generally performed by WDs. This may comprise specialized sensors for doing measurements for various purposes, interfaces for additional types of communication such as wired communications etc. The inclusion and type of components of auxiliary equipment 134 may vary depending on the embodiment and/or scenario.

Power source 136 may, in some embodiments, be in the form of a battery or battery pack. Other types of power sources, such as an external power source (e.g., an electricity outlet), photovoltaic devices or power cells, may also be used. WD 110 may further comprise power circuitry 137 for delivering power from power source 136 to the various parts of WD 110 which need power from power source 136 to carry out any functionality described or indicated herein. Power circuitry 137 may in certain embodiments comprise power management circuitry.

Power circuitry 137 may additionally or alternatively be operable to receive power from an external power source; in which case WD 110 may be connectable to the external power source (such as an electricity outlet) via input circuitry or an interface such as an electrical power cable. Power circuitry 137 may also in certain embodiments be operable to deliver power from an external power source to power source 136. This may be, for example, for the charging of power source 136. Power circuitry 137 may perform any formatting, converting, or other modification to the power from power source 136 to make the power suitable for the respective components of WD 110 to which power is supplied.

Although the subject matter described herein may be implemented in any appropriate type of system using any suitable components, the embodiments disclosed herein are described in relation to a wireless network, such as the example wireless network illustrated in FIG. 3. For simplicity, the wireless network of FIG. 3 only depicts network 106, network nodes 160 and 160b, and WDs 110, 110b, and 110c. In practice, a wireless network may further include any additional elements suitable to support communication between wireless devices or between a wireless device and another communication device, such as a landline telephone, a service provider, or any other network node or end device. Of the illustrated components, network node 160 and wireless device (WD) 110 are depicted with additional detail. The wireless network may provide communication and other types of services to one or more wireless devices to facilitate the wireless devices' access to and/or use of the services provided by, or via, the wireless network.

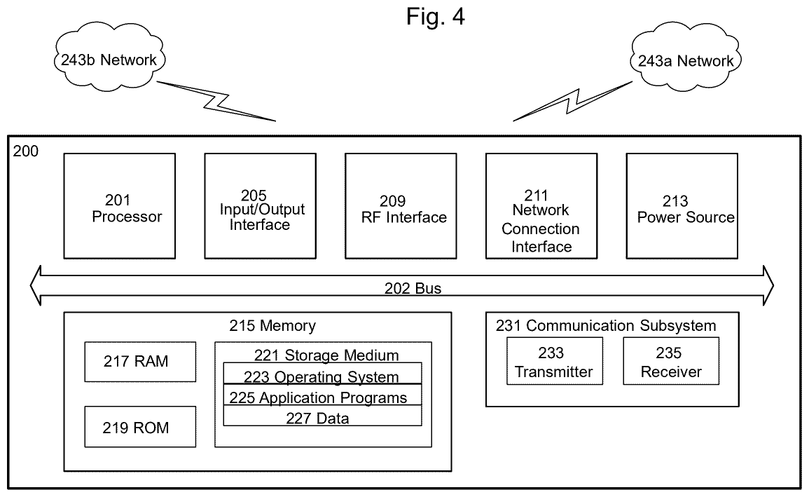

FIG. 4 illustrates an example user equipment, according to certain embodiments. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 200 may be any UE identified by the 3rd Generation Partnership Project (3GPP), including a NB-IoT UE, a machine type communication (MTC) UE, and/or an enhanced MTC (eMTC) UE. UE 200, as illustrated in FIG. 4, is one example of a WD configured for communication in accordance with one or more communication standards promulgated by the 3rd Generation Partnership Project (3GPP), such as 3GPP's GSM, UMTS, LTE, and/or 5G standards. As mentioned previously, the term WD and UE may be used interchangeable. Accordingly, although FIG. 4 is a UE, the components discussed herein are equally applicable to a WD, and vice-versa.

In FIG. 4, UE 200 includes processing circuitry 201 that is operatively coupled to input/output interface 205, radio frequency (RF) interface 209, network connection interface 211, memory 215 including random access memory (RAM) 217, read-only memory (ROM) 219, and storage medium 221 or the like, communication subsystem 231, power source 213, and/or any other component, or any combination thereof. Storage medium 221 includes operating system 223, application program 225, and data 227. In other embodiments, storage medium 221 may include other similar types of information. Certain UEs may use all the components shown in FIG. 4, or only a subset of the components. The level of integration between the components may vary from one UE to another UE. Further, certain UEs may contain multiple instances of a component, such as multiple processors, memories, transceivers, transmitters, receivers, etc.

In FIG. 4, processing circuitry 201 may be configured to process computer instructions and data. Processing circuitry 201 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 201 may include two central processing units (CPUs). Data may be information in a form suitable for use by a computer.

In the depicted embodiment, input/output interface 205 may be configured to provide a communication interface to an input device, output device, or input and output device. UE 200 may be configured to use an output device via input/output interface 205.

An output device may use the same type of interface port as an input device. For example, a USB port may be used to provide input to and output from UE 200. The output device may be a speaker, a sound card, a video card, a display, a monitor, a printer, an actuator, an emitter, a smartcard, another output device, or any combination thereof.

UE 200 may be configured to use an input device via input/output interface 205 to allow a user to capture information into UE 200. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 4, RF interface 209 may be configured to provide a communication interface to RF components such as a transmitter, a receiver, and an antenna. Network connection interface 211 may be configured to provide a communication interface to network 243a. Network 243a may encompass wired and/or wireless networks such as a local-area network (LAN), a wide-area network (WAN), a computer network, a wireless network, a telecommunications network, another like network or any combination thereof. For example, network 243a may comprise a Wi-Fi network. Network connection interface 211 may be configured to include a receiver and a transmitter interface used to communicate with one or more other devices over a communication network according to one or more communication protocols, such as Ethernet, TCP/IP, SONET, ATM, or the like. Network connection interface 211 may implement receiver and transmitter functionality appropriate to the communication network links (e.g., optical, electrical, and the like). The transmitter and receiver functions may share circuit components, software or firmware, or alternatively may be implemented separately.

RAM 217 may be configured to interface via bus 202 to processing circuitry 201 to provide storage or caching of data or computer instructions during the execution of software programs such as the operating system, application programs, and device drivers. ROM 219 may be configured to provide computer instructions or data to processing circuitry 201. For example, ROM 219 may be configured to store invariant low-level system code or data for basic system functions such as basic input and output (I/O), startup, or reception of keystrokes from a keyboard that are stored in a non-volatile memory.

Storage medium 221 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 221 may be configured to include operating system 223, application program 225 such as a web browser application, a widget or gadget engine or another application, and data file 227. Storage medium 221 may store, for use by UE 200, any of a variety of various operating systems or combinations of operating systems.

Storage medium 221 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 221 may allow UE 200 to access computer-executable instructions, application programs or the like, stored on transitory or non-transitory memory media, to off-load data, or to upload data. An article of manufacture, such as one utilizing a communication system may be tangibly embodied in storage medium 221, which may comprise a device readable medium.

In FIG. 4, processing circuitry 201 may be configured to communicate with network 243b using communication subsystem 231. Network 243a and network 243b may be the same network or networks or different network or networks. Communication subsystem 231 may be configured to include one or more transceivers used to communicate with network 243b. For example, communication subsystem 231 may be configured to include one or more transceivers used to communicate with one or more remote transceivers of another device capable of wireless communication such as another WD, UE, or base station of a radio access network (RAN) according to one or more communication protocols, such as IEEE 802.2, CDMA, WCDMA, GSM, LTE, UTRAN, WiMax, or the like. Each transceiver may include transmitter 233 and/or receiver 235 to implement transmitter or receiver functionality, respectively, appropriate to the RAN links (e.g., frequency allocations and the like). Further, transmitter 233 and receiver 235 of each transceiver may share circuit components, software or firmware, or alternatively may be implemented separately.

In the illustrated embodiment, the communication functions of communication subsystem 231 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 231 may include cellular communication, Wi-Fi communication, Bluetooth communication, and GPS communication. Network 243b may encompass wired and/or wireless networks such as a local-area network (LAN), a wide-area network (WAN), a computer network, a wireless network, a telecommunications network, another like network or any combination thereof. For example, network 243b may be a cellular network, a Wi-Fi network, and/or a near-field network. Power source 213 may be configured to provide alternating current (AC) or direct current (DC) power to components of UE 200.

The features, benefits and/or functions described herein may be implemented in one of the components of UE 200 or partitioned across multiple components of UE 200. Further, the features, benefits, and/or functions described herein may be implemented in any combination of hardware, software or firmware. In one example, communication subsystem 231 may be configured to include any of the components described herein. Further, processing circuitry 201 may be configured to communicate with any of such components over bus 202. In another example, any of such components may be represented by program instructions stored in memory that when executed by processing circuitry 201 perform the corresponding functions described herein. In another example, the functionality of any of such components may be partitioned between processing circuitry 201 and communication subsystem 231. In another example, the non-computationally intensive functions of any of such components may be implemented in software or firmware and the computationally intensive functions may be implemented in hardware.

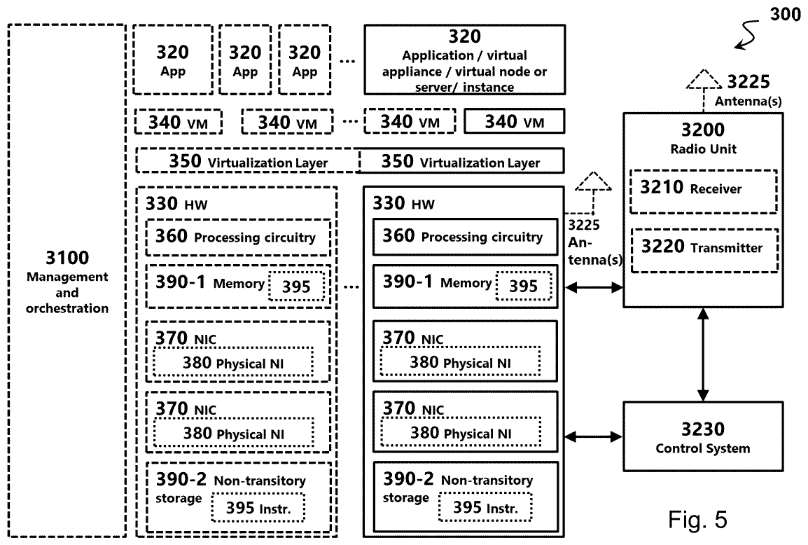

FIG. 5 is a schematic block diagram illustrating a virtualization environment 300 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 300 hosted by one or more of hardware nodes 330. Further, in embodiments in which the virtual node is not a radio access node or does not require radio connectivity (e.g., a core network node), then the network node may be entirely virtualized.

The functions may be implemented by one or more applications 320 (which may alternatively be called software instances, virtual appliances, network functions, virtual nodes, virtual network functions, etc.) operative to implement some of the features, functions, and/or benefits of some of the embodiments disclosed herein. Applications 320 are run in virtualization environment 300 which provides hardware 330 comprising processing circuitry 360 and memory 390. Memory 390 contains instructions 395 executable by processing circuitry 360 whereby application 320 is operative to provide one or more of the features, benefits, and/or functions disclosed herein.

Virtualization environment 300, comprises general-purpose or special-purpose network hardware devices 330 comprising a set of one or more processors or processing circuitry 360, which may be commercial off-the-shelf (COTS) processors, dedicated Application Specific Integrated Circuits (ASICs), or any other type of processing circuitry including digital or analog hardware components or special purpose processors. Each hardware device may comprise memory 390-1 which may be non-persistent memory for temporarily storing instructions 395 or software executed by processing circuitry 360. Each hardware device may comprise one or more network interface controllers (NICs) 370, also known as network interface cards, which include physical network interface 380. Each hardware device may also include non-transitory, persistent, machine-readable storage media 390-2 having stored therein software 395 and/or instructions executable by processing circuitry 360. Software 395 may include any type of software including software for instantiating one or more virtualization layers 350 (also referred to as hypervisors), software to execute virtual machines 340 as well as software allowing it to execute functions, features and/or benefits described in relation with some embodiments described herein.

Virtual machines 340, comprise virtual processing, virtual memory, virtual networking or interface and virtual storage, and may be run by a corresponding virtualization layer 350 or hypervisor. Different embodiments of the instance of virtual appliance 320 may be implemented on one or more of virtual machines 340, and the implementations may be made in different ways.

During operation, processing circuitry 360 executes software 395 to instantiate the hypervisor or virtualization layer 350, which may sometimes be referred to as a virtual machine monitor (VMM). Virtualization layer 350 may present a virtual operating platform that appears like networking hardware to virtual machine 340.

As shown in FIG. 5, hardware 330 may be a standalone network node with generic or specific components. Hardware 330 may comprise antenna 3225 and may implement some functions via virtualization. Alternatively, hardware 330 may be part of a larger cluster of hardware (e.g. such as in a data center or customer premise equipment (CPE)) where many hardware nodes work together and are managed via management and orchestration (MANO) 3100, which, among others, oversees lifecycle management of applications 320.

Virtualization of the hardware is in some contexts referred to as network function virtualization (NFV). NFV may be used to consolidate many network equipment types onto industry standard high-volume server hardware, physical switches, and physical storage, which can be located in data centers, and customer premise equipment.

In the context of NFV, virtual machine 340 may be a software implementation of a physical machine that runs programs as if they were executing on a physical, non-virtualized machine. Each of virtual machines 340, and that part of hardware 330 that executes that virtual machine, be it hardware dedicated to that virtual machine and/or hardware shared by that virtual machine with others of the virtual machines 340, forms a separate virtual network elements (VNE).

Still in the context of NFV, Virtual Network Function (VNF) is responsible for handling specific network functions that run in one or more virtual machines 340 on top of hardware networking infrastructure 330 and corresponds to application 320 in FIG. 18.

In some embodiments, one or more radio units 3200 that each include one or more transmitters 3220 and one or more receivers 3210 may be coupled to one or more antennas 3225. Radio units 3200 may communicate directly with hardware nodes 330 via one or more appropriate network interfaces and may be used in combination with the virtual components to provide a virtual node with radio capabilities, such as a radio access node or a base station.

In some embodiments, some signaling can be effected with the use of control system 3230 which may alternatively be used for communication between the hardware nodes 330 and radio units 3200.

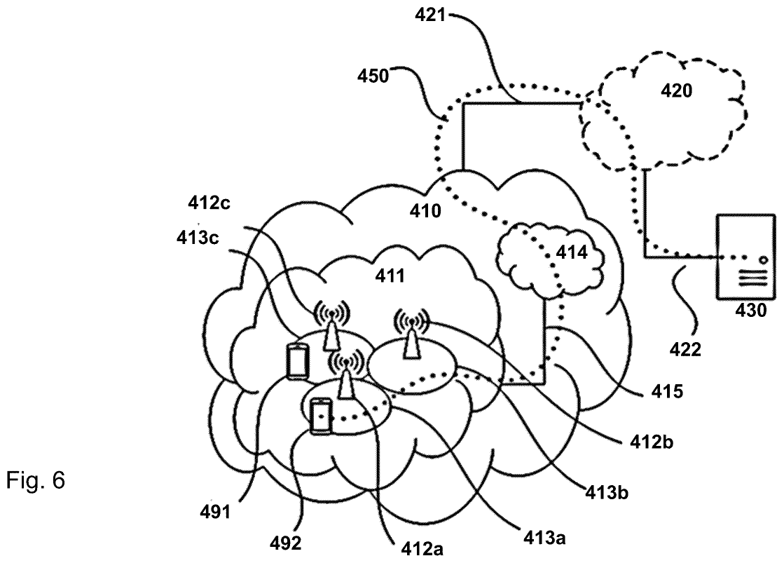

With reference to FIG. 6, in accordance with an embodiment, a communication system includes telecommunication network 410, such as a 3GPP-type cellular network, which comprises access network 411, such as a radio access network, and core network 414. Access network 411 comprises a plurality of base stations 412a, 412b, 412c, such as NBs, eNBs, gNBs or other types of wireless access points, each defining a corresponding coverage area 413a, 413b, 413c. Each base station 412a, 412b, 412c is connectable to core network 414 over a wired or wireless connection 415. A first UE 491 located in coverage area 413c is configured to wirelessly connect to, or be paged by, the corresponding base station 412c. A second UE 492 in coverage area 413a is wirelessly connectable to the corresponding base station 412a. While a plurality of UEs 491, 492 are illustrated in this example, the disclosed embodiments are equally applicable to a situation where a sole UE is in the coverage area or where a sole UE is connecting to the corresponding base station 412.

Telecommunication network 410 is itself connected to host computer 430, which may be embodied in the hardware and/or software of a standalone server, a cloud-implemented server, a distributed server or as processing resources in a server farm. Host computer 430 may be under the ownership or control of a service provider or may be operated by the service provider or on behalf of the service provider. Connections 421 and 422 between telecommunication network 410 and host computer 430 may extend directly from core network 414 to host computer 430 or may go via an optional intermediate network 420. Intermediate network 420 may be one of, or a combination of more than one of, a public, private or hosted network; intermediate network 420, if any, may be a backbone network or the Internet; in particular, intermediate network 420 may comprise two or more sub-networks (not shown).

The communication system of FIG. 6 as a whole enables connectivity between the connected UEs 491, 492 and host computer 430. The connectivity may be described as an over-the-top (OTT) connection 450. Host computer 430 and the connected UEs 491, 492 are configured to communicate data and/or signaling via OTT connection 450, using access network 411, core network 414, any intermediate network 420 and possible further infrastructure (not shown) as intermediaries. OTT connection 450 may be transparent in the sense that the participating communication devices through which OTT connection 450 passes are unaware of routing of uplink and downlink communications. For example, base station 412 may not or need not be informed about the past routing of an incoming downlink communication with data originating from host computer 430 to be forwarded (e.g., handed over) to a connected UE 491. Similarly, base station 412 need not be aware of the future routing of an outgoing uplink communication originating from the UE 491 towards the host computer 430.

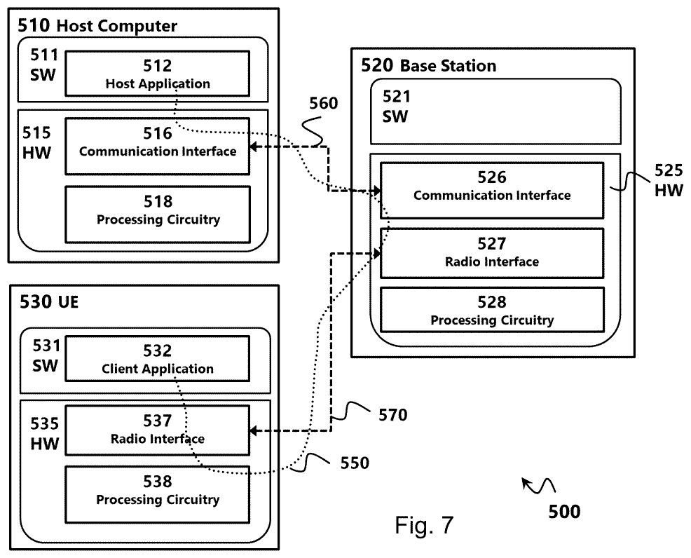

FIG. 7 illustrates an example host computer communicating via a base station with a user equipment over a partially wireless connection, according to certain embodiments. Example implementations, in accordance with an embodiment of the UE, base station and host computer discussed in the preceding paragraphs will now be described with reference to FIG. 7. In communication system 500, host computer 510 comprises hardware 515 including communication interface 516 configured to set up and maintain a wired or wireless connection with an interface of a different communication device of communication system 500. Host computer 510 further comprises processing circuitry 518, which may have storage and/or processing capabilities. In particular, processing circuitry 518 may comprise one or more programmable processors, application-specific integrated circuits, field programmable gate arrays or combinations of these (not shown) adapted to execute instructions. Host computer 510 further comprises software 511, which is stored in or accessible by host computer 510 and executable by processing circuitry 518. Software 511 includes host application 512. Host application 512 may be operable to provide a service to a remote user, such as UE 530 connecting via OTT connection 550 terminating at UE 530 and host computer 510. In providing the service to the remote user, host application 512 may provide user data which is transmitted using OTT connection 550.

Communication system 500 further includes base station 520 provided in a telecommunication system and comprising hardware 525 enabling it to communicate with host computer 510 and with UE 530. Hardware 525 may include communication interface 526 for setting up and maintaining a wired or wireless connection with an interface of a different communication device of communication system 500, as well as radio interface 527 for setting up and maintaining at least wireless connection 570 with UE 530 located in a coverage area (not shown in FIG. 7) served by base station 520. Communication interface 526 may be configured to facilitate connection 560 to host computer 510. Connection 560 may be direct, or it may pass through a core network (not shown in FIG. 7) of the telecommunication system and/or through one or more intermediate networks outside the telecommunication system. In the embodiment shown, hardware 525 of base station 520 further includes processing circuitry 528, which may comprise one or more programmable processors, application-specific integrated circuits, field programmable gate arrays or combinations of these (not shown) adapted to execute instructions. Base station 520 further has software 521 stored internally or accessible via an external connection.

Communication system 500 further includes UE 530 already referred to. Its hardware 535 may include radio interface 537 configured to set up and maintain wireless connection 570 with a base station serving a coverage area in which UE 530 is currently located. Hardware 535 of UE 530 further includes processing circuitry 538, which may comprise one or more programmable processors, application-specific integrated circuits, field programmable gate arrays or combinations of these (not shown) adapted to execute instructions. UE 530 further comprises software 531, which is stored in or accessible by UE 530 and executable by processing circuitry 538. Software 531 includes client application 532. Client application 532 may be operable to provide a service to a human or non-human user via UE 530, with the support of host computer 510. In host computer 510, an executing host application 512 may communicate with the executing client application 532 via OTT connection 550 terminating at UE 530 and host computer 510. In providing the service to the user, client application 532 may receive request data from host application 512 and provide user data in response to the request data. OTT connection 550 may transfer both the request data and the user data. Client application 532 may interact with the user to generate the user data that it provides.

It is noted that host computer 510, base station 520 and UE 530 illustrated in FIG. 7 may be similar or identical to host computer 430, one of base stations 412a, 412b, 412c and one of UEs 491, 492 of FIG. 3, respectively. This is to say, the inner workings of these entities may be as shown in FIG. 7 and independently, the surrounding network topology may be that of FIG. 3.

In FIG. 7, OTT connection 550 has been drawn abstractly to illustrate the communication between host computer 510 and UE 530 via base station 520, without explicit reference to any intermediary devices and the precise routing of messages via these devices. Network infrastructure may determine the routing, which it may be configured to hide from UE 530 or from the service provider operating host computer 510, or both. While OTT connection 550 is active, the network infrastructure may further take decisions by which it dynamically changes the routing (e.g., based on load balancing consideration or reconfiguration of the network).

Wireless connection 570 between UE 530 and base station 520 is in accordance with the teachings of the embodiments described throughout this disclosure. One or more of the various embodiments improve the performance of OTT services provided to UE 530 using OTT connection 550, in which wireless connection 570 forms the last segment. More precisely, the teachings of these embodiments may improve the signaling overhead and reduce latency, which may provide faster internet access for users.

A measurement procedure may be provided for monitoring data rate, latency and other factors on which the one or more embodiments improve. There may further be an optional network functionality for reconfiguring OTT connection 550 between host computer 510 and UE 530, in response to variations in the measurement results. The measurement procedure and/or the network functionality for reconfiguring OTT connection 550 may be implemented in software 511 and hardware 515 of host computer 510 or in software 531 and hardware 535 of UE 530, or both. In embodiments, sensors (not shown) may be deployed in or in association with communication devices through which OTT connection 550 passes; the sensors may participate in the measurement procedure by supplying values of the monitored quantities exemplified above or supplying values of other physical quantities from which software 511, 531 may compute or estimate the monitored quantities. The reconfiguring of OTT connection 550 may include message format, retransmission settings, preferred routing etc.; the reconfiguring need not affect base station 520, and it may be unknown or imperceptible to base station 520. Such procedures and functionalities may be known and practiced in the art. In certain embodiments, measurements may involve proprietary UE signaling facilitating host computer 510's measurements of throughput, propagation times, latency and the like. The measurements may be implemented in that software 511 and 531 causes messages to be transmitted, in particular empty or ‘dummy’ messages, using OTT connection 550 while it monitors propagation times, errors etc.

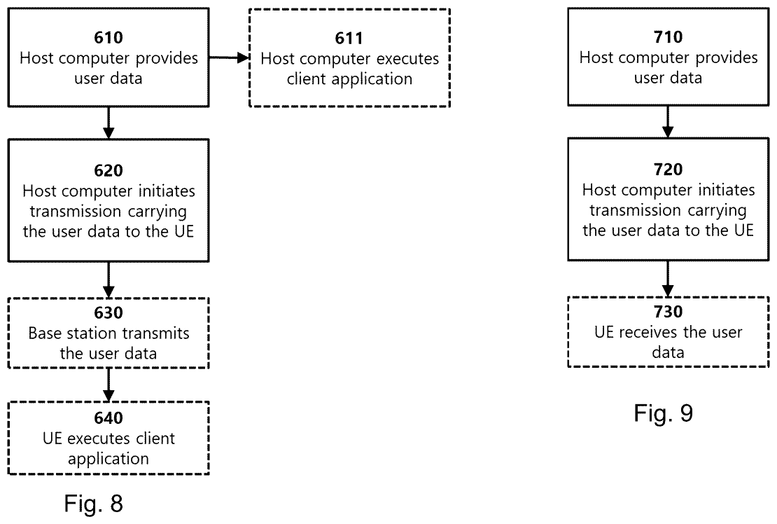

FIG. 8 is a flowchart illustrating a method implemented in a communication system, in accordance with one embodiment. The communication system includes a host computer, a base station and a UE which may be those described with reference to FIGS. 6 and 7. For simplicity of the present disclosure, only drawing references to FIG. 8 will be included in this section.

In step 610, the host computer provides user data. In substep 611 (which may be optional) of step 610, the host computer provides the user data by executing a host application. In step 620, the host computer initiates a transmission carrying the user data to the UE. In step 630 (which may be optional), the base station transmits to the UE the user data which was carried in the transmission that the host computer initiated, in accordance with the teachings of the embodiments described throughout this disclosure. In step 640 (which may also be optional), the UE executes a client application associated with the host application executed by the host computer.

FIG. 9 is a flowchart illustrating a method implemented in a communication system, in accordance with one embodiment. The communication system includes a host computer, a base station and a UE which may be those described with reference to FIGS. 6 and 7. For simplicity of the present disclosure, only drawing references to FIG. 9 will be included in this section.

In step 710 of the method, the host computer provides user data. In an optional substep (not shown) the host computer provides the user data by executing a host application. In step 720, the host computer initiates a transmission carrying the user data to the UE. The transmission may pass via the base station, in accordance with the teachings of the embodiments described throughout this disclosure. In step 730 (which may be optional), the UE receives the user data carried in the transmission.

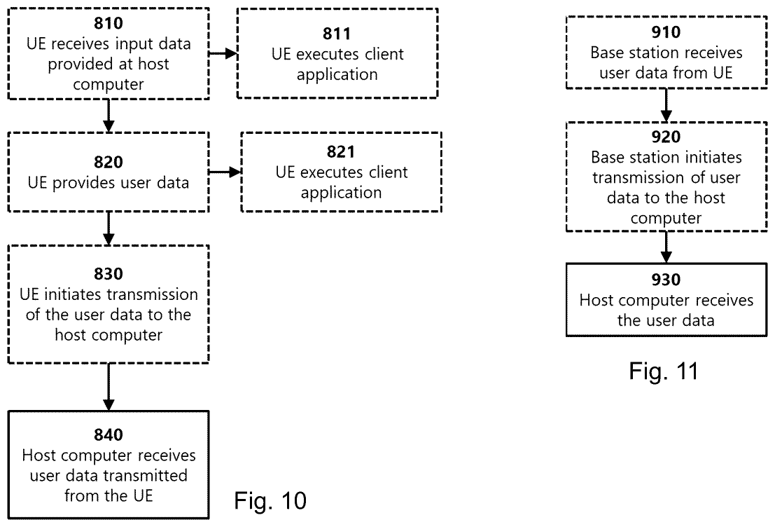

FIG. 10 is a flowchart illustrating a method implemented in a communication system, in accordance with one embodiment. The communication system includes a host computer, a base station and a UE which may be those described with reference to FIGS. 6 and 7. For simplicity of the present disclosure, only drawing references to FIG. 10 will be included in this section.

In step 810 (which may be optional), the UE receives input data provided by the host computer. Additionally, or alternatively, in step 820, the UE provides user data. In substep 821 (which may be optional) of step 820, the UE provides the user data by executing a client application. In substep 811 (which may be optional) of step 810, the UE executes a client application which provides the user data in reaction to the received input data provided by the host computer. In providing the user data, the executed client application may further consider user input received from the user. Regardless of the specific manner in which the user data was provided, the UE initiates, in substep 830 (which may be optional), transmission of the user data to the host computer. In step 840 of the method, the host computer receives the user data transmitted from the UE, in accordance with the teachings of the embodiments described throughout this disclosure.

FIG. 11 is a flowchart illustrating a method implemented in a communication system, in accordance with one embodiment. The communication system includes a host computer, a base station and a UE which may be those described with reference to FIGS. 6 and 7. For simplicity of the present disclosure, only drawing references to FIG. 11 will be included in this section.

In step 910 (which may be optional), in accordance with the teachings of the embodiments described throughout this disclosure, the base station receives user data from the UE. In step 920 (which may be optional), the base station initiates transmission of the received user data to the host computer. In step 930 (which may be optional), the host computer receives the user data carried in the transmission initiated by the base station.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Modifications, additions, or omissions may be made to the systems and apparatuses disclosed herein without departing from the scope of the invention. The components of the systems and apparatuses may be integrated or separated. Moreover, the operations of the systems and apparatuses may be performed by more, fewer, or other components. Additionally, operations of the systems and apparatuses may be performed using any suitable logic comprising software, hardware, and/or other logic. As used in this document, “each” refers to each member of a set or each member of a subset of a set.

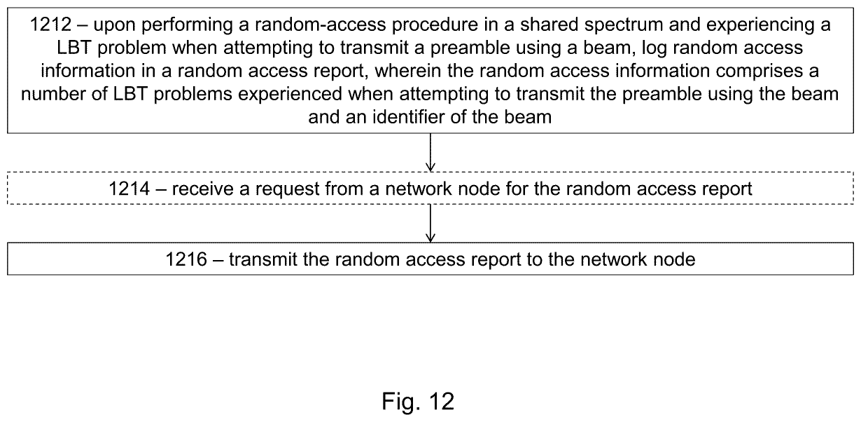

FIG. 12 is a flowchart illustrating an example method 1200 performed by a wireless device, according to particular embodiments. In particular embodiments, one or more steps of FIG. 12 may be performed by wireless device 110 described with respect to FIG. 3.

The method may begin at step 1212, where the wireless device (e.g., wireless device 110), upon performing a random-access procedure in a shared spectrum and experiencing a LBT problem when attempting to transmit a preamble using a beam, logs random access information in a random access report. The random access information comprises a number of LBT problems experienced when attempting to transmit the preamble using the beam and an identifier of the beam. In particular embodiments, the identifier of the beam comprises one of a SSB identifier or a CSI-RS identifier.

In particular embodiments, the random access information is logged as part of RA-InformationCommon. The RA-InformationCommon may be included in a radio link failure report, successful handover report (SHR), or successful PSCell change/addition report (SPR).

In particular embodiments, the random access information is included: only as part of per random access SSB information (e.g., as part of PerRASSBInfo-r16 IE); only as part of a radio link failure (RLF) report; only as part of a random access (RA) report; only as part of RA-InformationCommon; or as part of/together with a successful handover report. The random access information may be included: only as part of per random access CSI-RS information (e.g. as part of PerCSI-RSInfor-r16 IE); as part of per random access SSB information and part of per random access CSI-RS information; as part of RLF report and part of a RA report, but not part of RA-InformationCommon; together with a RLF report; together with a RA report; as part of/together with a connection establishment failure report; or as part of/together with a successful PSCell change/addition report.

In particular embodiments, the wireless device logs LBT failures according to one or more of the following conditions: for SSB beams; for CSI-RS beams; for a mobility procedure; for a preparation phase of a mobility procedure; for an execution phase of a mobility procedure; only for a source shared channel/source cell of a mobility procedure; only for a target shared channel/target cell of a mobility procedure; for both a source shared channel/source cell and a target shared channel/target cell of a mobility procedure; for initial access; for PSCell change; for PSCell addition; for a reconfiguration with synchronization associated to a specific purpose; upon transitioning from RRC_IDLE to RRC_CONNECTED state; upon transitioning from RRC_INACTIVE to RRC_CONNECTED state; upon transitioning between single connectivity and multi-connectivity operation; and in conjunction with a trigger of a radio related event.

In particular embodiments, the wireless device logs LBT failures according to any of the embodiments and examples described herein.

At step 1214, the wireless device may receive a request from the network node for the random access report. The request may comprise one or more of: a part of a RLF report configuration; a part of a RA report configuration; a part of both RLF report and RA report configuration (e.g., to be reported as part of RA-InformationCommon); a part of a successful handover report (SHR) configuration; and a part of a successful PSCell change/addition report (SPR or SPCR) configuration.

In other embodiments, the wireless device may determine when to send random access report without a request from the network node and the method continues to step 1216.

At step 1216, the wireless device transmits the random access report to a network node. The wireless device may transmit the random access report directly to the network node, or via another network node.

Modifications, additions, or omissions may be made to method 1200 of FIG. 12. Additionally, one or more steps in the method of FIG. 12 may be performed in parallel or in any suitable order.

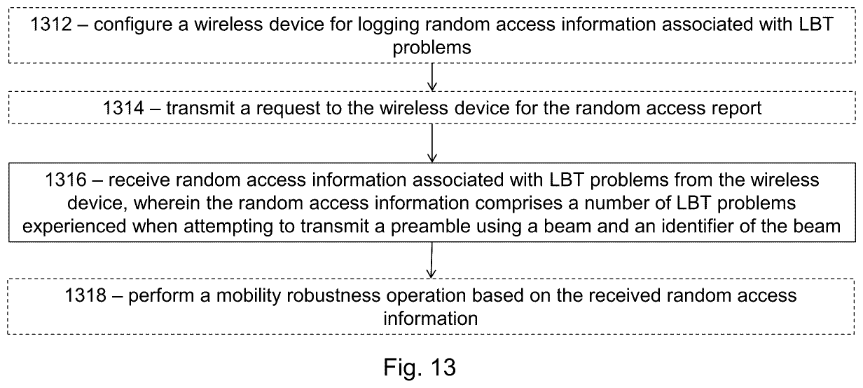

FIG. 13 is a flowchart illustrating an example method 1300 performed by a network node, according to particular embodiments. In particular embodiments, one or more steps of FIG. 13 may be performed by network node 160 described with respect to FIG. 3.

The method may begin at step 1312, where a network node (e.g., network node 160) configures a wireless device for logging random access information associated with LBT problems.

At step 1314, the network node may transmit a request to the wireless device for a random access report. The request is described in more detail with respect to step 1214 of FIG. 12 and the embodiments and examples described above.

In some embodiments, the network node may not transmit the request and the method continues to step 1316.

At step 1316, the network node receives random access information associated with LBT problems from the wireless device. The random access information comprises a number of LBT problems experienced when attempting to transmit a preamble using a beam and an identifier of the beam. The random access information is described in more detail with respect to step 1212 of FIG. 12 and the embodiments and examples described above.

At step 1318, the network node may perform a mobility robustness operation based on the received random access information. For example, the network node may use the random access information to analyze the impact of LBT issues when performing random access procedures for various purpose such as mobility procedures or beam failure recovery or for specific feature(s) (e.g., Msg3 repetition or small data transmission (SDT) operation) activation, etc.

Modifications, additions, or omissions may be made to method 1300 of FIG. 13. Additionally, one or more steps in the method of FIG. 13 may be performed in parallel or in any suitable order.

Modifications, additions, or omissions may be made to the methods disclosed herein without departing from the scope of the invention. The methods may include more, fewer, or other steps. Additionally, steps may be performed in any suitable order.

The foregoing description sets forth numerous specific details. It is understood, however, that embodiments may be practiced without these specific details. In other instances, well-known circuits, structures and techniques have not been shown in detail in order not to obscure the understanding of this description. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments, whether or not explicitly described.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the scope of this disclosure, as defined by the claims below.

### EXAMPLE EMBODIMENTS

### Group A Embodiments

1. A method performed by a wireless device, the method comprising:
   upon performing a random-access procedure in a shared spectrum and experiencing a listen before talk (LBT) problem when attempting to transmit a preamble using a beam, logging random access information in a random access report; and
   transmitting the random access report to a network node.
2. The method of embodiment 1, wherein the random access information comprises a number of LBT problems experienced when attempting to transmit the preamble using the beam.
3. The method of any of the previous embodiments, wherein the random access information is logged as part of RA-InformationCommon.
4. The method of the previous embodiment, wherein the RA-InformationCommon is included in a radio link failure report or in a successful handover report.
5. The method of any one of the previous embodiments, wherein the random access information is included:
   only as part of per Random Access SSB Information (e.g., as part of PerRASSBInfo-r16 IE)
   only as part of per Random Access CSI-RS Information (e.g. as part of PerCSI-RSInfor-r16 IE)
   as part of per Random Access SSB Information and part of per Random Access CSI-RS Information
   only as part of an RLF report
   only as part of a RA report
   only as part of RA-InformationCommon
   as part of RLF report and part of a RA report, but not part of RA-InformationCommon
   together with a RLF report
   together with a RA report
   as part of/together with a Successful Handover Report
   as part of/together with a Connection Establishment Failure Report
   as part of/together with a Successful PSCell change/addition report
   as part of/together with a new UE report
6. The method of any of the previous embodiments, further comprising receiving a request from the network node for the random access report.
7. The method of the previous embodiment, wherein the request comprises one or more of:
   part of a RLF report configuration
   part of a RA report configuration
   part of both RLF report and RA report configuration (e.g. to be reported as part of RA-InformationCommon)
   part of a SHR report configuration
   part of a SPR (or SPCR) report configuration
8. The method of any one of the previous embodiments, wherein the wireless device logs LBT failures according to one or more of the following conditions:
   for SSB beams
   for CSI-RS beams
   for a mobility procedure
   for the preparation phase of a mobility procedure
   for the execution phase of a mobility procedure
   only for the source shared channel/source cell of a mobility procedure
   only for the target shared channel/target cell of a mobility procedure
   for both the source shared channel/source cell and the target shared channel/target cell of a mobility procedure
   for initial access
   for PSCell change
   for PSCell addition
   for a reconfiguration with synch associated to a specific purpose
   upon transitioning from RRC_IDLE to RRC_CONNECTED state
   upon transitioning from RRC_INACTIVE to RRC_CONNECTED state
   upon transitioning from single connectivity to multi-connectivity operation or vice versa
   in conjunction with the trigger of a certain radio related event (e.g. when event A3, or event A5 is triggered)
9. A method performed by a wireless device, the method comprising:
   any of the wireless device steps, features, or functions described above, either alone or in combination with other steps, features, or functions described above.
10. The method of the previous embodiment, further comprising one or more additional wireless device steps, features or functions described above.
11. The method of any of the previous embodiments, further comprising:
   providing user data; and
   forwarding the user data to a host computer via the transmission to the base station.

### Group B Embodiments

12. A method performed by a base station, the method comprising:
   configuring a wireless device for logging random access information associated with listen before talk (LBT) problems; and
   receiving random access information associated with LBT problems from the wireless device.
13. The method of the previous embodiment, wherein the random access information comprises a number of LBT problems experienced when attempting to transmit a preamble using a beam.
14. The method of any one of the previous embodiments, further comprising performing a mobility robustness operation based on the received random access information.
15. A method performed by a base station, the method comprising:
   any of the steps, features, or functions described above with respect to base station, either alone or in combination with other steps, features, or functions described above.
16. The method of the previous embodiment, further comprising one or more additional base station steps, features or functions described above.
17. The method of any of the previous embodiments, further comprising:
   obtaining user data; and
   forwarding the user data to a host computer or a wireless device.

### Group C Embodiments

18. A mobile terminal comprising:
   processing circuitry configured to perform any of the steps of any of the Group A embodiments; and
   power supply circuitry configured to supply power to the wireless device.
19. A base station comprising:
   processing circuitry configured to perform any of the steps of any of the Group B embodiments;
   power supply circuitry configured to supply power to the wireless device.
20. A user equipment (UE) comprising:
   an antenna configured to send and receive wireless signals;
   radio front-end circuitry connected to the antenna and to processing circuitry, and configured to condition signals communicated between the antenna and the processing circuitry;
   the processing circuitry being configured to perform any of the steps of any of the Group A embodiments;
   an input interface connected to the processing circuitry and configured to allow input of information into the UE to be processed by the processing circuitry;
   an output interface connected to the processing circuitry and configured to output information from the UE that has been processed by the processing circuitry; and
   a battery connected to the processing circuitry and configured to supply power to the UE.
21. A communication system including a host computer comprising:
   processing circuitry configured to provide user data; and
   a communication interface configured to forward the user data to a cellular network for transmission to a user equipment (UE),
   wherein the cellular network comprises a base station having a radio interface and processing circuitry, the base station's processing circuitry configured to perform any of the steps of any of the Group B embodiments.
22. The communication system of the pervious embodiment further including the base station.
23. The communication system of the previous 2 embodiments, further including the UE, wherein the UE is configured to communicate with the base station.
24. The communication system of the previous 3 embodiments, wherein:
   the processing circuitry of the host computer is configured to execute a host application, thereby providing the user data; and
   the UE comprises processing circuitry configured to execute a client application associated with the host application.
25. A method implemented in a communication system including a host computer, a base station and a user equipment (UE), the method comprising:
   at the host computer, providing user data; and
   at the host computer, initiating a transmission carrying the user data to the UE via a cellular network comprising the base station, wherein the base station performs any of the steps of any of the Group B embodiments.
26. The method of the previous embodiment, further comprising, at the base station, transmitting the user data.
27. The method of the previous 2 embodiments, wherein the user data is provided at the host computer by executing a host application, the method further comprising, at the UE, executing a client application associated with the host application.
28. A user equipment (UE) configured to communicate with a base station, the UE comprising a radio interface and processing circuitry configured to performs any of the previous 3 embodiments.
29. A communication system including a host computer comprising:
   processing circuitry configured to provide user data; and
   a communication interface configured to forward user data to a cellular network for transmission to a user equipment (UE),
   wherein the UE comprises a radio interface and processing circuitry, the UE's components configured to perform any of the steps of any of the Group A embodiments.
30. The communication system of the previous embodiment, wherein the cellular network further includes a base station configured to communicate with the UE.
31. The communication system of the previous 2 embodiments, wherein:
   the processing circuitry of the host computer is configured to execute a host application, thereby providing the user data; and
   the UE's processing circuitry is configured to execute a client application associated with the host application.
32. A method implemented in a communication system including a host computer, a base station and a user equipment (UE), the method comprising:
   at the host computer, providing user data; and
   at the host computer, initiating a transmission carrying the user data to the UE via a cellular network comprising the base station, wherein the UE performs any of the steps of any of the Group A embodiments.
33. The method of the previous embodiment, further comprising at the UE, receiving the user data from the base station.
34. A communication system including a host computer comprising:
   communication interface configured to receive user data originating from a transmission from a user equipment (UE) to a base station,
   wherein the UE comprises a radio interface and processing circuitry, the UE's processing circuitry configured to perform any of the steps of any of the Group A embodiments.
35. The communication system of the previous embodiment, further including the UE.
36. The communication system of the previous 2 embodiments, further including the base station, wherein the base station comprises a radio interface configured to communicate with the UE and a communication interface configured to forward to the host computer the user data carried by a transmission from the UE to the base station.
37. The communication system of the previous 3 embodiments, wherein:
   the processing circuitry of the host computer is configured to execute a host application; and
   the UE's processing circuitry is configured to execute a client application associated with the host application, thereby providing the user data.
38. The communication system of the previous 4 embodiments, wherein:
   the processing circuitry of the host computer is configured to execute a host application, thereby providing request data; and
   the UE's processing circuitry is configured to execute a client application associated with the host application, thereby providing the user data in response to the request data.
39. A method implemented in a communication system including a host computer, a base station and a user equipment (UE), the method comprising:
   at the host computer, receiving user data transmitted to the base station from the UE, wherein the UE performs any of the steps of any of the Group A embodiments.
40. The method of the previous embodiment, further comprising, at the UE, providing the user data to the base station.
41. The method of the previous 2 embodiments, further comprising:
   at the UE, executing a client application, thereby providing the user data to be transmitted; and
   at the host computer, executing a host application associated with the client application.
42. The method of the previous 3 embodiments, further comprising:
   at the UE, executing a client application; and
   at the UE, receiving input data to the client application, the input data being provided at the host computer by executing a host application associated with the client application,
   wherein the user data to be transmitted is provided by the client application in response to the input data.
43. A communication system including a host computer comprising a communication interface configured to receive user data originating from a transmission from a user equipment (UE) to a base station, wherein the base station comprises a radio interface and processing circuitry, the base station's processing circuitry configured to perform any of the steps of any of the Group B embodiments.
44. The communication system of the previous embodiment further including the base station.
45. The communication system of the previous 2 embodiments, further including the UE, wherein the UE is configured to communicate with the base station.
46. The communication system of the previous 3 embodiments, wherein:
   the processing circuitry of the host computer is configured to execute a host application;
   the UE is configured to execute a client application associated with the host application, thereby providing the user data to be received by the host computer.
47. A method implemented in a communication system including a host computer, a base station and a user equipment (UE), the method comprising:
   at the host computer, receiving, from the base station, user data originating from a transmission which the base station has received from the UE, wherein the UE performs any of the steps of any of the Group A embodiments.
48. The method of the previous embodiment, further comprising at the base station, receiving the user data from the UE.
49. The method of the previous 2 embodiments, further comprising at the base station, initiating a transmission of the received user data to the host computer.

1. A method performed by a wireless device, the method comprising:
upon performing a random-access procedure in a shared spectrum and experiencing a listen-before-talk (LBT) problem when attempting to transmit a preamble using a beam, logging random access information in a random access report, wherein the random access information comprises a number of LBT problems experienced when attempting to transmit the preamble using the beam and an identifier of the beam; and
transmitting the random access report to a network node.

2. The method of claim 1, wherein the identifier of the beam comprises one of a synchronization signal block (SSB) identifier or a channel state information reference signal (CSI-RS) identifier.

3. The method of claim 1, wherein the random access information is logged as part of RA-InformationCommon.

4. The method of claim 3, wherein the RA-InformationCommon is included in a radio link failure report, successful handover report (SHR), or successful PSCell change/addition report (SPR).

5. The method of claim 1, wherein the random access information is included:
only as part of per random access synchronization signal block (SSB) information;
only as part of a radio link failure (RLF) report;
only as part of a random access (RA) report;
only as part of RA-InformationCommon; or
as part of/together with a successful handover report.

6. The method of claim 1, wherein the random access information is included:
only as part of per random access channel state information reference signal (CSI-RS) information;
as part of per random access synchronization signal block (SSB) information and part of per random access CSI-RS information;
as part of radio link failure (RLF) report and part of a random access (RA) report, but not part of RA-InformationCommon;
together with a RLF report;
together with a RA report;
as part of/together with a connection establishment failure report; or
as part of/together with a successful PSCell change/addition report.

7. The method of claim 1, further comprising receiving (1214) a request from the network node for the random access report.

8. The method of claim 7, wherein the request comprises one or more of:
a part of a radio link failure (RLF) report configuration;
a part of a random access (RA) report configuration;
a part of both RLF report and RA report configuration;
a part of a successful handover report (SHR) configuration; and
a part of a successful PSCell change/addition report (SPR) configuration.

9. The method of claim 1, wherein the wireless device logs LBT failures according to one or more of the following conditions:
for synchronization signal block (SSB) beams;
for channel state information reference signal (CSI-RS) beams;
for a mobility procedure;
for a preparation phase of a mobility procedure;
for an execution phase of a mobility procedure;
only for a source shared channel/source cell of a mobility procedure;
only for a target shared channel/target cell of a mobility procedure;
for both a source shared channel/source cell and a target shared channel/target cell of a mobility procedure;
for initial access;
for PSCell change;
for PSCell addition;
for a reconfiguration with synchronization associated to a specific purpose;
upon transitioning from RRC_IDLE to RRC_CONNECTED state;
upon transitioning from RRC_INACTIVE to RRC_CONNECTED state;
upon transitioning between single connectivity and multi-connectivity operation; and
in conjunction with a trigger of a radio related event.

10. A wireless device comprising processing circuitry, the processing circuitry operable to:
upon performing a random-access procedure in a shared spectrum and experiencing a listen-before-talk (LBT) problem when attempting to transmit a preamble using a beam, log random access information in a random access report, wherein the random access information comprises a number of LBT problems experienced when attempting to transmit the preamble using the beam and an identifier of the beam; and
transmit the random access report to a network node.

11. The wireless device of claim 10, wherein the identifier of the beam comprises one of a synchronization signal block (SSB) identifier or a channel state information reference signal (CSI-RS) identifier.

12. The wireless device of claim 10, wherein the random access information is logged as part of RA-InformationCommon.

13. The wireless device of claim 12, wherein the RA-InformationCommon is included in a radio link failure report, successful handover report (SHR), or successful PSCell change/addition report (SPR).

14. The wireless device of claim 10, wherein the random access information is included:
only as part of per random access synchronization signal block (SSB) information;
only as part of a radio link failure (RLF) report;
only as part of a random access (RA) report;
only as part of RA-InformationCommon; or
as part of/together with a successful handover report.

15. The wireless device of claim 10, wherein the random access information is included:
only as part of per random access channel state information reference signal (CSI-RS) information;
as part of per random access synchronization signal block (SSB) information and part of per random access CSI-RS information;
as part of radio link failure (RLF) report and part of a random access (RA) report, but not part of RA-InformationCommon;
together with a RLF report;
together with a RA report;
as part of/together with a connection establishment failure report; or
as part of/together with a successful PSCell change/addition report.

16. The wireless device of claim 10, the processing circuitry further operable to receive a request from the network node for the random access report.

17. The wireless device of claim 16, wherein the request comprises one or more of:
a part of a radio link failure (RLF) report configuration;
a part of a random access (RA) report configuration;
a part of both RLF report and RA report configuration;
a part of a successful handover report (SHR) configuration; and
a part of a successful PSCell change/addition report (SPR) configuration.

18. The wireless device of claim 10 wherein the wireless device logs LBT failures according to one or more of the following conditions:
for synchronization signal block (SSB) beams;
for channel state information reference signal (CSI-RS) beams;
for a mobility procedure;
for a preparation phase of a mobility procedure;
for an execution phase of a mobility procedure;
only for a source shared channel/source cell of a mobility procedure;
only for a target shared channel/target cell of a mobility procedure;
for both a source shared channel/source cell and a target shared channel/target cell of a mobility procedure;
for initial access;
for PSCell change;
for PSCell addition;
for a reconfiguration with synchronization associated to a specific purpose;
upon transitioning from RRC_IDLE to RRC_CONNECTED state;
upon transitioning from RRC_INACTIVE to RRC_CONNECTED state;
upon transitioning between single connectivity and multi-connectivity operation; and
in conjunction with a trigger of a radio related event.

19. A method performed by a network node, the method comprising:
configuring a wireless device for logging random access information associated with listen-before-talk (LBT) problems; and
receiving random access information associated with LBT problems from the wireless device, wherein the random access information comprises a number of LBT problems experienced when attempting to transmit a preamble using a beam and an identifier of the beam.

20.-25. (canceled)

26. A network node comprising processing circuitry, the processing circuitry operable to:
configure a wireless device for logging random access information associated with listen-before-talk (LBT) problems; and
receive random access information associated with LBT problems from the wireless device, wherein the random access information comprises a number of LBT problems experienced when attempting to transmit a preamble using a beam and an identifier of the beam.

27. The network node of claim 26, the processing circuitry further operable to perform a mobility robustness operation based on the received random access information.

28. The network node of claim 26, the processing circuitry further operable to transmit a request to the wireless device for the random access report.

29. The network node of claim 28, wherein the request comprises one or more of:
a part of a radio link failure (RLF) report configuration;
a part of a random access (RA) report configuration;
a part of both RLF report and RA report configuration;
a part of a successful handover report (SHR) configuration; and
a part of a successful PSCell change/addition report (SPR) configuration.

30. The network node of claim 26, wherein the identifier of the beam comprises one of a synchronization signal block (SSB) identifier or a channel state information reference signal (CSI-RS) identifier.

31. The network node of claim 26, wherein the random access information is included:
only as part of per random access synchronization signal block (SSB) information;
only as part of a radio link failure (RLF) report;
only as part of a random access (RA) report;
only as part of RA-InformationCommon; or
as part of/together with a successful handover report.

32. The network node of claim 26, wherein the random access information is included:
only as part of per random access channel state information reference signal (CSI-RS) information;
as part of per random access synchronization signal block (SSB) information and part of per random access CSI-RS information;
as part of radio link failure (RLF) report and part of a random access (RA) report, but not part of RA-InformationCommon;
together with a RLF report;
together with a RA report;
as part of/together with a connection establishment failure report; or
as part of/together with a successful PSCell change/addition report.
